(19) United States
(12) Patent Application Publication
(10) Pub. No.: US 2025/0052882 A1
(43) Pub. Date: Feb. 13, 2025

(54) SENSING MEASUREMENT METHOD, AND DEVICE

(71) Applicant: GUANGDONG OPPO MOBILE TELECOMMUNICATIONS CORP., LTD., Dongguan (CN)

(72) Inventors: Chaoming LUO, Dongguan (CN); Lei HUANG, Singapore (SG)

(21) Appl. No.: 18/915,315

(22) Filed: Oct. 14, 2024

Related U.S. Application Data
(63) Continuation of application No. PCT/CN2022/111926, filed on Aug. 11, 2022.

(30) Foreign Application Priority Data
Apr. 26, 2022 (WO) PCT/CN2022/089414

(51) Int. Cl. G01S 13/04

(52) U.S. Cl. CPC G01S 13/04

(57) ABSTRACT

Provided is a sensing measurement method. The method is applicable to a sensing-by-proxy initiator. The method includes: transmitting a sensing-by-proxy request frame to a sensing-by-proxy responder, wherein the sensing-by-proxy request frame is for requesting the sensing-by-proxy responder to perform sensing measurement on behalf of the sensing-by-proxy initiator; and receiving a sensing-by-proxy response frame from the sensing-by-proxy responder.

### CROSS-REFERENCE TO RELATED APPLICATION

This application is a continuation of International Application No. PCT/CN2022/111926, filed Aug. 11, 2022, which claims priority to Chinese Patent Application No. PCT/CN2022/089414, filed Apr. 26, 2022, the entire disclosures of which are incorporated herein by reference.

### TECHNICAL FIELD

Embodiments of the present disclosure relate to the field of wireless communications, and in particular, relate to a sensing measurement method and apparatus, and a device and a storage medium thereof.

### BACKGROUND

Wireless local area networks (WLAN) sensing indicates a technology for sensing a person or object in an environment by detecting changes of a WLAN signal scattered and/or reflected by the person or object.

### SUMMARY

Embodiments of the present disclosure provide a sensing measurement method and apparatus, and a device and a storage medium thereof. The technical solutions are as follows.

In some embodiments of the present disclosure, a sensing measurement method is provided. The method is applicable to a sensing-by-proxy initiator, and includes:
transmitting a sensing-by-proxy request frame to a sensing-by-proxy responder, wherein the sensing-by-proxy request frame is for requesting the sensing-by-proxy responder to perform sensing measurement on behalf of the sensing-by-proxy initiator; and
receiving a sensing-by-proxy response frame from the sensing-by-proxy responder.

In some embodiments of the present disclosure, a wireless local area network (WLAN) device is provided. The WLAN device includes: a processor and a memory storing one or more computer programs, wherein the processor, when calling and running the one or more computer programs, is caused to perform the above sensing measurement method.

In some embodiments of the present disclosure, a wireless local area network (WLAN) device is provided. The WLAN device includes: a processor and a memory storing one or more computer programs, wherein the processor, when calling and running the one or more computer programs, is caused to perform: receiving a sensing-by-proxy request frame from a sensing-by-proxy initiator, wherein the sensing-by-proxy request frame is for requesting the sensing-by-proxy responder to perform sensing measurement by proxy; and transmitting a sensing-by-proxy response frame to the sensing-by-proxy initiator.

### BRIEF DESCRIPTION OF DRAWINGS

FIG. 1 is a schematic diagram of a wireless communication system according to some embodiments of the present disclosure;

FIG. 2 is a schematic diagram of a typical scenario of performing sensing measurement based on a sensing signal according to some embodiments of the present disclosure;

FIG. 3 is a schematic diagram of a typical scenario of performing sensing measurement based on a sensing signal according to some embodiments of the present disclosure;

FIG. 4 is a schematic diagram of sensing measurement according to some embodiments of the present disclosure;

FIG. 5 is a schematic diagram of establishing sensing measurement according to some embodiments of the present disclosure;

FIG. 6 is a schematic diagram of setting up measurement parameters according to some embodiments of the present disclosure;

FIG. 7 is a schematic diagram of a measurement process according to some embodiments of the present disclosure;

FIG. 8 is a schematic diagram of a measurement process according to some embodiments of the present disclosure;

FIG. 9 is a schematic diagram of a measurement process according to some embodiments of the present disclosure;

FIG. 10 is a flowchart of a sensing measurement method according to some embodiments of the present disclosure;

FIG. 11 is a schematic diagram of a sensing-by-proxy request frame according to some embodiments of the present disclosure;

FIG. 12 is a schematic diagram of a sensing-by-proxy request frame according to some embodiments of the present disclosure;

FIG. 13 is a schematic diagram of a sensing-by-proxy response frame according to some embodiments of the present disclosure;

FIG. 14 is a schematic diagram of a measurement process according to some embodiments of the present disclosure;

FIG. 15 is a schematic diagram of a measurement process according to some embodiments of the present disclosure;

FIG. 16 is a schematic diagram of a measurement process according to some embodiments of the present disclosure;

FIG. 17 is a schematic diagram of a measurement process according to some embodiments of the present disclosure;

FIG. 18 is a schematic diagram of an Extended Capabilities element according to some embodiments of the present disclosure;

FIG. 19 is a schematic diagram of a Sensing Capabilities element according to some embodiments of the present disclosure;

FIG. 20 is a flowchart of a capability interaction method according to some embodiments of the present disclosure;

FIG. 21 is a block diagram of a sensing measurement apparatus according to some embodiments of the present disclosure;

FIG. 22 is a block diagram of a sensing measurement apparatus according to some embodiments of the present disclosure;

FIG. 23 is a block diagram of a capability interaction apparatus according to some embodiments of the present disclosure; and

FIG. 24 is a block diagram of a WLAN device according to some embodiments of the present disclosure.

### DETAILED DESCRIPTION

For clearer descriptions of the objectives, technical solutions, and advantages of the present disclosure, embodiments of the present disclosure are described in detail hereinafter in conjunction with the accompanying drawings.

The network architecture and service scenarios in the embodiments of the present disclosure are intended to describe the technical solutions according to the embodiments of the present disclosure clearer, and are not construed as limitations on the technical solutions according to the embodiments of the present disclosure. It is understandable by those of ordinary skill in the art that with the evolution of the network architecture and occurrence of new service scenarios, the technical solutions according to the embodiments of the present disclosure are also applicable to solving similar technical problems.

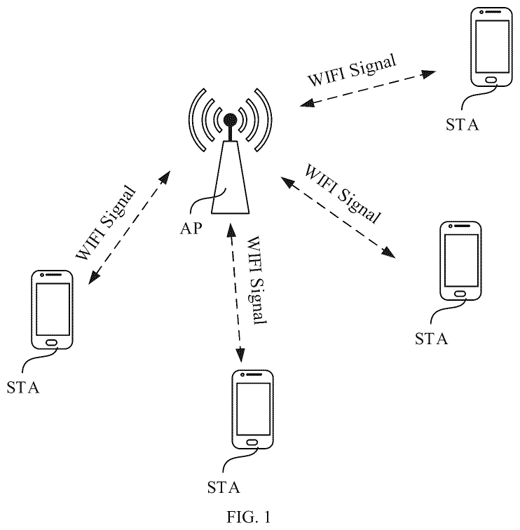

Referring to FIG. 1, FIG. 1 is a schematic diagram of a wireless communication system according to some embodiments of the present disclosure. As shown in FIG. 1, the wireless communication system includes an access point (AP) and a station (STA).

In some scenarios, the AP is also referred to as an AP STA. That is, the AP is an STA in some way. In some scenarios, the STA is also referred to as a non-AP STA.

In some scenarios, the STA includes an AP STA and a non-AP STA. Communications in the communication system include the communication between the AP and the non-AP STA, the communication between the non-AP STA and the non-AP STA, or the communication between the STA and a peer STA. The peer STA indicates a device communicated with an opposite end of the STA. For example, the peer STA is an AP or a non-AP STA.

The AP is a bridge to connect the wired network to the wireless network, and mainly functions as connecting various wireless network clients and accessing the wireless network to the Ethernet. The AP device is a terminal device (for example, a mobile phone) including a wireless fidelity (Wi-Fi) chip or a network device (for example, a router).

It should be noted that the function of the STA in the communication system is not absolute. For example, in some scenarios, the mobile phone is the non-AP STA in the case that the mobile phone is connected to the router, and the mobile phone is the AP in the case that the mobile phone is the hotspot of other mobile phones.

The AP and the non-AP STA are devices applicable to an internet of vehicles, an Internet of things (IoT) node or sensor in the IoT, a smart camera, a smart remote control, a smart water meter and the like in the smart home, a sensor in the smart city, and the like.

In some embodiments, the non-AP STA supports an 802.11be format. In some embodiments, the non-AP STA also supports various current and future wireless local area network (WLAN) formats of the 802.11 family, such as an 802.11ax format, an 802.11ac format, an 802.11n format, an 802.11g format, an 802.11b format, an 802.11a format, and the like.

In some embodiments, the AP supports the 802.11be format. The AP also supports various current and future WLAN formats of the 802.11 family, such as an 802.11ax format, an 802.11ac format, an 802.11n format, an 802.11g format, an 802.11b format, an 802.11a format, and the like.

In some embodiments, the STA is a mobile phone, a pad, a computer, a virtual reality (VR) device, an augmented reality (AR) device, an industrial control wireless device, a set-top box, a self-driving wireless device, an in-vehicle communication device, a remote medical wireless device, a smart grid wireless device, a transportation safety wireless device, a smart city or smart home wireless device, a wireless communication chip/application specific integrated circuit (ASIC)/system on chip (SoC), and the like that support the WLAN/Wi-Fi technologies.

The WLAN supports frequency bands including, but not limited to a low frequency band (2.4 GHz, 5 GHz, or 6 GHZ), and a high frequency band (45 GHz or 60 GHz).

One or more links are present between the STA and the AP. In some embodiments, the STA and the AP supports multi-frequency-band communications, for example, simultaneous communication at frequency bands of 2.4 GHZ, 5 GHZ, 6 GHZ, 45 GHZ, and 60 GHZ, or simultaneous communication on different channels at a same frequency band (or different frequency band), such that a communication throughput and/or reliability between devices are improved. Such device is generally referred to as a multi-frequency-band device, a multi-link device (MLD), a multi-link entity, or a multi-frequency-band entity. The MLD is an AP device or an STA device. In the case that the MLD is an AP device, the MLD includes one or more APs. In the case that the MLD is an STA device, the MLD includes one or more non-AP STAs.

An MLD including one or more APs can be referred to as an AP, and an MLD including one or more non-AP STAs can be referred to as a non-AP.

In the embodiments of the present disclosure, the AP includes a plurality of APs, and the non-AP includes a plurality of STAs. A plurality of links are formed between the APs in the AP and the STAs in the non-AP, and data communication between the APs in the AP and the STAs in the non-AP is achieved over corresponding links.

The AP is a device deployed in the WLAN for providing a wireless communication function to the STA. The STA includes a user equipment (UE), an access terminal, a subscriber unit, a subscriber station, a mobile station, a mobile console, a remote station, a remote terminal, a mobile device, a wireless communication device, a user agent, a user device, or the like. In some embodiments, the STA is a cellular phone, a cordless phone, a Session Initiation Protocol (SIP) phone, a wireless local loop (WLL) station, a personal digital assistant (PDA), a hand-held device with a wireless communication capability, a computing device or other processing devices connected to a wireless modem, an in-vehicle device, a wearable device, which is not limited in the embodiments of the present disclosure.

In some embodiments, the STA and the AP all support the IEEE 802.11 standard.

Prior to description of the technical solutions according to the present disclosure, background technical knowledge involved in the present disclosure is introduced. The following related arts may be determined as optional solutions and may be arbitrarily combined with the technical solutions according to the embodiments of the present disclosure, which shall fall within the scope of protection of the embodiments of the present disclosure. The embodiments of the present disclosure include at least some of the following content.

### 1. WLAN Sensing and Participant

The WLAN sensing indicates a method and application for sensing a person or object in an environment by detecting changes of a WLAN signal scattered and/or reflected by the person or object. WLAN terminals participating in the sensing may include a sensing measurement initiator, a sensing measurement responder, a sensing signal transmitter, a sensing signal receiver, and other roles. In some embodiments, devices participating in the WLAN sensing include a sensing initiator (that is, a sensing measurement initiator) and a sensing responder (that is, a sensing measurement responder). Alternatively, devices participating in the WLAN sensing include a sensing transmitter (that is, a sensing signal transmitter) and a sending receiver (that is, a sensing signal receiver).

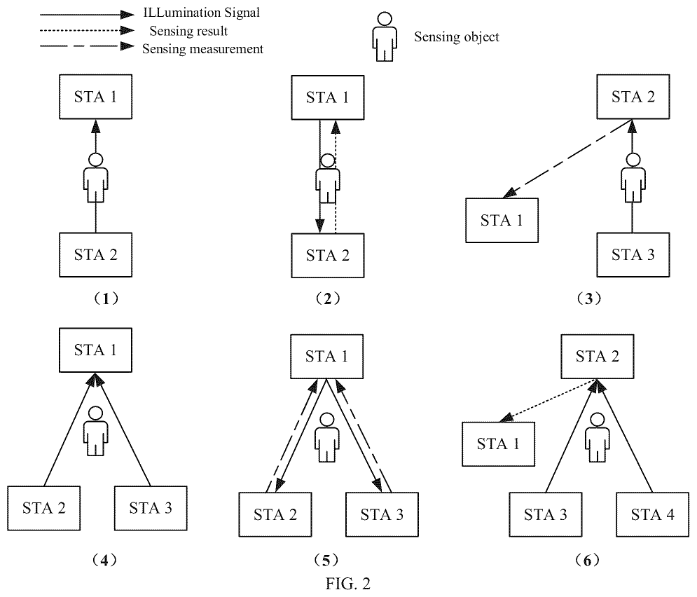

FIG. 2(1) to FIG. 2(6) show six typical scenarios of performing WLAN sensing based on sensing signals according to some embodiments of the present disclosure.

In some embodiments, the WLAN sensing is a one-way interaction process in which an STA transmits a sensing signal to another STA. As shown in FIG. 2(1), the WLAN sensing is that an STA2 transmits a sensing signal to an STA1.

In some embodiments, the WLAN sensing is an interaction process between two STAs.

As shown in FIG. 2(2), the WLAN sensing is that the STA1 transmits a sensing signal to the STA2, and the STA2 transmits a measurement report to the STA1.

In some embodiments, the WLAN sensing is combination of a plurality of one-way information interaction processes. As shown in FIG. 2(3), the WLAN sensing is that an STA3 transmits a sensing signal to the STA2, and the STA2 transmits measurement configuration to STA1.

In some embodiments, the WLAN sensing is that a plurality of STAs transmit sensing signals to a same STA. As shown in FIG. 2(4), the WLAN sensing is that the STA2 and the STA3 transmit sensing signals to the STA1.

In some embodiments, the WLAN sensing is information interaction between an STA and a plurality of STAs. As shown in FIG. 2(5), the WLAN sensing is that the STA1 transmits sensing signals to the STA2 and the STA3, and the STA2 and the STA3 transmit measurement configuration to STA1.

In some embodiments, as shown in FIG. 2(6), the WLAN sensing is that a plurality of STAs (for example, the STA3 and an STA4) transmit sensing signals to the STA2, and the STA2 transmits a measurement report to the STA1.

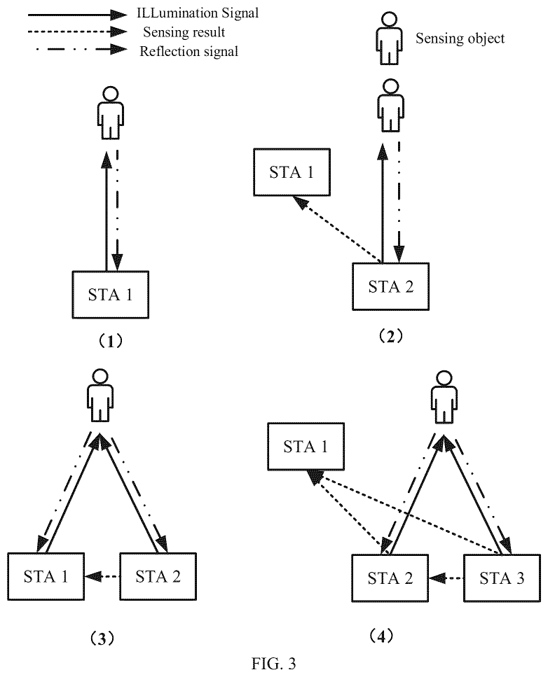

FIG. 3(1) to FIG. 3(4) show four typical scenarios of performing WLAN sensing based on sensing signals and reflection signals according to some embodiments of the present disclosure.

In some embodiments, as shown in FIG. 3(1), a sensing signal from the STA1 reaches a sensing object, the sensing object reflects the sensing signal, and the STA1 receives the reflection signal.

In some embodiments, as shown in FIG. 3(2), a sensing signal from the STA2 reaches a sensing object, the sensing object reflects the sensing signal, and the STA2 receives the reflection signal.

In some embodiments, as shown in FIG. 3(3), sensing signals respectively from the STA1 and the STA2 reach a sensing object, the sensing object reflects the sensing signals from the STA1 and the STA2, the STA 1 and the STA2 respectively receive the signals reflected by the sensing object, and STA2 transmits a measurement report to the STA1 (that is, the measurement report is shared synchronously between STAs).

In some embodiments, as shown in FIG. 3(4), sensing signals respectively from the STA3 and the STA2 reach a sensing object, the sensing object reflects the sensing signals from the STA3 and the STA2, the STA 3 and the STA2 respectively receive the signals reflected by the sensing object, the STA3 transmits a measurement report to the STA1 and the STA2, and the STA2 also transmits the measurement report to the STA1 (that is, the measurement report is shared synchronously between STAs).

### 2. A Whole Process of WLAN Sensing Measurement

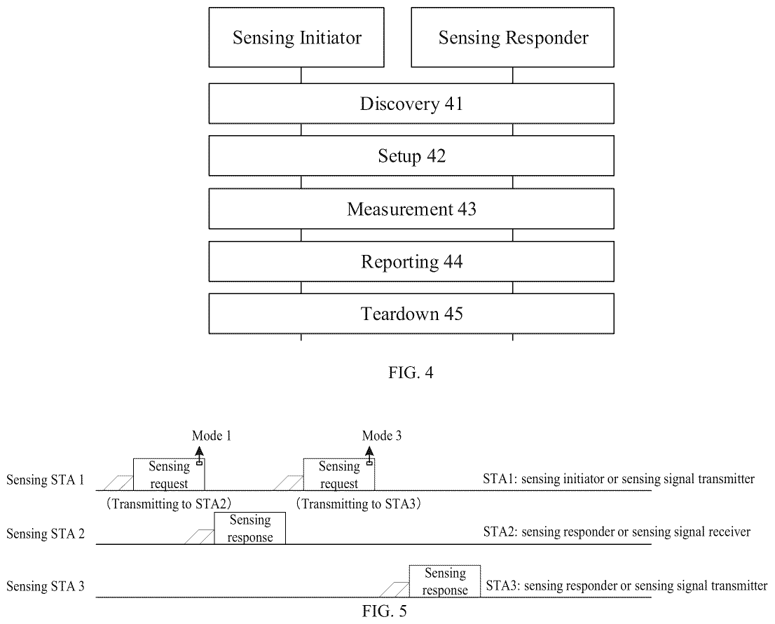

As shown in FIG. 4, the WLAN sensing measurement includes one or more of following phases: a sensing discovery phase 41, a measurement establishment phase 42, a sensing measurement phase 43, a sensing reporting phase 44, and a measurement termination (teardown) phase 45. A same WLAN terminal may play one or more roles in sensing measurement. For example, a sensing initiator is not only a sensing initiator, but also a sensing transmitter, a sensing receiver, or a sensing transmitter and a sensing receiver.

The sensing discovery phase is for initiating sensing measurement.

The measurement establishment phase is for establishing the sensing measurement, determining sensing measurement participants and roles thereof (including a sensing transmitter and a sensing receiver), determining operation parameters related to the sensing measurement, and interacting the parameters between terminals optionally.

The sensing measurement phase is for performing the sensing measurement, and the sensing transmitter transmits a sensing signal to the sensing receivers.

The sensing reporting phase is for reporting a measurement report, and the sensing receiver may be required to report the measurement report to the sensing measurement initiator, which is determined based on an application scenario.

The measurement termination phase is for the terminal to terminate the measurement and terminate the sensing measurement.

### 3. Negotiation of Parameters of WLAN Sensing Measurement

As shown in FIG. 5, in establishing the sensing measurement, the terminal needs to negotiate sensing roles and operation parameters one by one, or the terminal announces own roles and operation parameters (for example, through beacon frames or other special frames). For example, a sensing STA1, a sensing STA2, and a sensing STA3 negotiate sensing roles and operation parameters through sensing requests and sensing responses. In some embodiments, the sensing STA1 is the sensing initiator or the sensing transmitter, the sensing STA2 is the sensing responder or the sensing receiver, and the sensing STA3 is the sensing responder or the sensing transmitter.

### 4. Measurement Setup and Measurement Instances

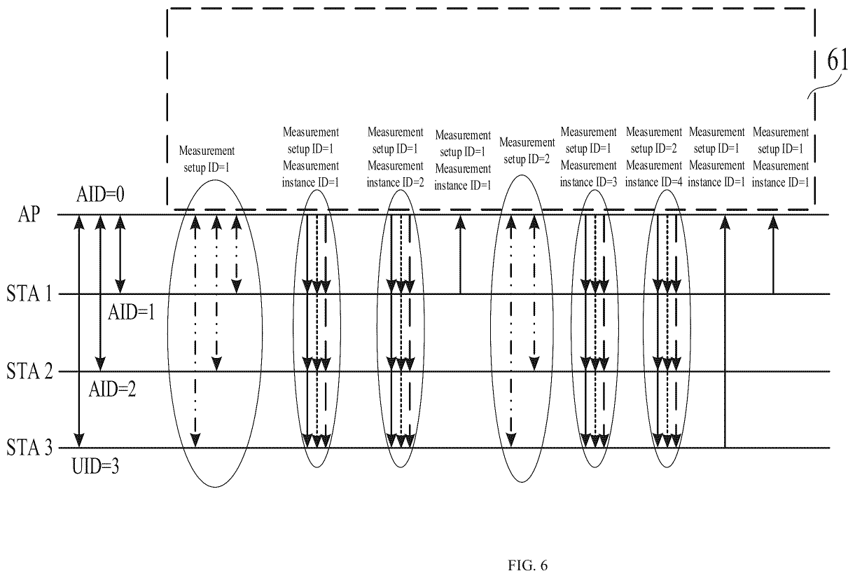

As shown in FIG. 6, the sensing initiator sets several sets of measurement parameters 61, and one set of measurement parameters (identified by measurement setup identifier (ID) 61, and equivalent to burst group) are applicable to several measurements (identified by measurement instance ID, and equivalent to burst).

### 5. Non-Trigger Based (Non-TB) Measurement Procedures

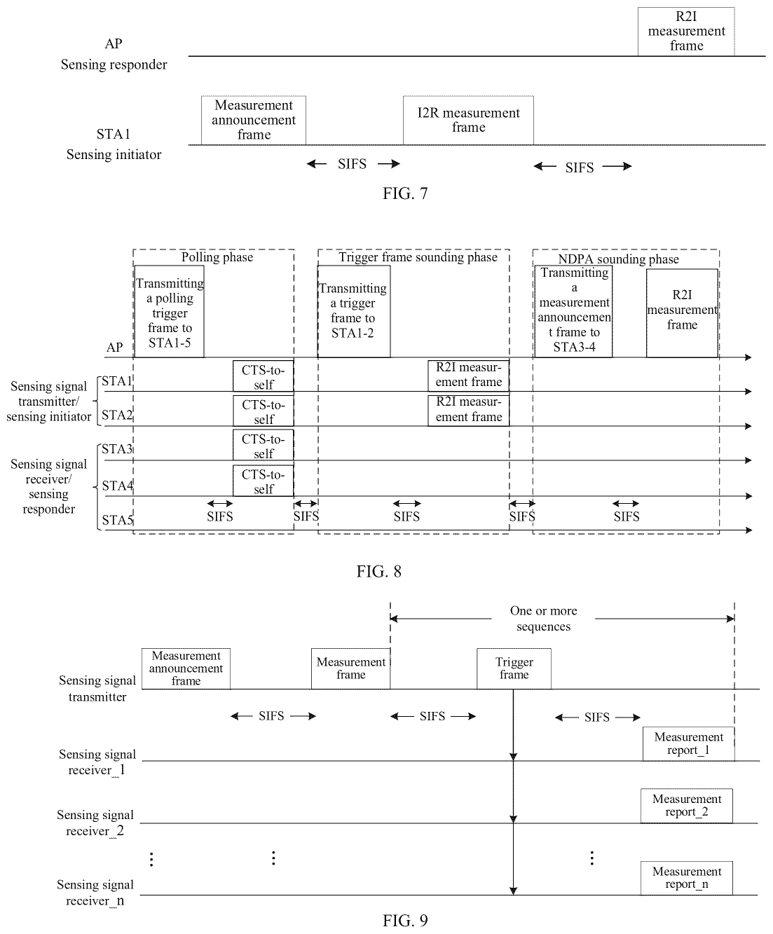

In some embodiments, as shown in FIG. 7, in the case that only one pair of devices are used for sensing measurement, the non-TB measurement procedure is used. The sensing initiator transmits a null data packet (NDP) announcement frame (NDPA) to announce start of the measurement, and transmits an initiator to responder (I2R) NDP after a short inter-frame space (SIFS) time. The sensing responder receives the NDP and transmits a responder to initiator (R2I) NDP after an SIFS time. The two devices perform different processing based on roles determined in the measurement setup. If the sensing initiator is only the sensing signal transmitter, the sensing responder is only the sensing signal receiver and the sensing responder generates a sensing measurement report after receiving the I2R NDP. If the sensing initiator is only the sensing signal receiver, the sensing responder is only the sensing signal transmitter and the sensing initiator generates a sensing measurement report after receiving the R2I NDP. If the sensing initiator is both the sensing signal transmitter and the sensing signal receiver, the sensing responder is both the sensing signal receiver and the sensing signal transmitter and both the sensing initiator and the sensing responder generate sensing measurement reports.

### 6. Trigger Based (TB) Measurement Procedures

In some embodiments, as shown in FIG. 8, in the case that a plurality of (more than two) devices participate in sensing measurement, the TB measurement procedure is used generally to improve an efficiency. In a polling phase, the AP transmits a sensing polling trigger frame (TF) to detect whether the sensing participants intend to participate in the sensing measurement. In a TF sounding phase, the AP transmits a TF frame to trigger the STA to transmit the NDP. In a NDPA sounding phase, the AP transmits an NDPA frame and an NDP.

In some embodiments, as shown in FIG. 9, the sensing transmitter transmits a feedback trigger frame after transmitting an NDP, and the sensing signal receiver reports a measurement report to the sensing signal transmitter after receiving the trigger frame.

In the sensing measurement, the measurement report is reported by an explicit request initiated by the sensing initiator (for example, triggered by a sensing feedback request frame or a sensing report trigger frame) or is reported by an implicit request initiated by the sensing initiator (for example, triggered by the NDP). The measurement report is reported immediately or delayed. The delayed report is generally reported by an explicit request initiated by the sensing initiator.

Terms involved in the embodiments of the present disclosure are described hereinafter.

Association ID (AID) is for identifying a terminal associated with the AP.

Medium access control (MAC) stands for a medium access control protocol or a medium access control address.

Transmission opportunity (TXOP) indicates a duration in which a device having the TXOP may actively initiate one or more transmissions.

WLAN sensing indicates sensing a person or object in an environment by detecting changes of a WLAN signal scattered and/or reflected by the person or object. That is, in the WLAN sensing, a surrounding environment is measured and detected based on a wireless signal to achieve various functions, for example, detection of indoor intrusions/movements/fall, gesture recognition, and spatial three dimensions image construction.

WLAN devices participating in the WLAN sensing have following roles:
a sensing initiator is a device initiating sensing measurement and desiring to obtain a sensing report;
a sensing responder is a non-sensing initiator device participating in the sensing measurement;
a sensing signal transmitter, or referred to as a sensing transmitter, is a device transmitting a sensing measurement signal (a sensing illumination signal);
a sensing signal receiver, or referred to as a sensing receiver, is a device receiving a sensing measurement signal;
a sensing-by-proxy initiator, also referred to as a proxy requester or a sensing-by-proxy requester, is a device requesting other devices to initiate the sensing measurement;
a sensing-by-proxy responder, also referred to as a sensing proxy STA or a sensing proxy responder, is a device responding to a request of the sensing-by-proxy initiator and initiating sensing measurement;
a sensing processor is a device processing a measurement report; and
a sensing participant includes a sensing initiator, a sensing signal transmitter, and a sensing signal receiver that participating in sensing measurement; or only includes non-sensing initiator devices participating in the sensing measurement in the embodiments of the present disclosure, and in this case, the sensing participant is the same as the sensing responder.

WLAN terminal plays one or more roles in sensing measurement. For example, a sensing initiator is only a sensing initiator, a sensing signal transmitter, a sensing signal receiver, or a sensing signal transmitter and a signal sensing receiver.

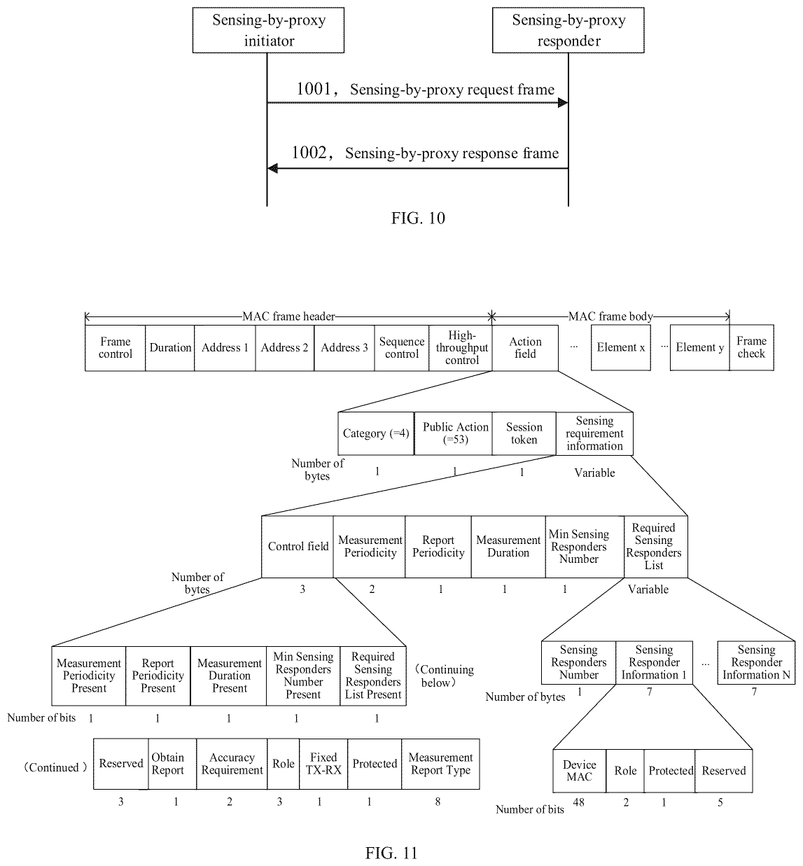

Referring to FIG. 10, a flowchart of a sensing measurement method according to some embodiments of the present disclosure is illustrated. The method includes following processes (1001 to 1002).

In S1001, a sensing-by-proxy initiator transmits a sensing-by-proxy request frame to a sensing-by-proxy responder, wherein the sensing-by-proxy request frame is for requesting the sensing-by-proxy responder to perform sensing measurement on behalf of the sensing-by-proxy initiator.

In some embodiments, the sensing-by-proxy initiator transmits the sensing-by-proxy request frame to the sensing-by-proxy responder, and the sensing-by-proxy responder initiates the sensing measurement after receiving the sensing-by-proxy request frame. That is, the sensing-by-proxy initiator initiates the sensing measurement through the sensing-by-proxy responder. In some embodiments, the sensing-by-proxy initiator needs to indicate sensing requirement information to the sensing-by-proxy responder, and the sensing-by-proxy responder generates corresponding sensing measurement configuration information based on the sensing requirement information and establishes the sensing measurement process with appropriate sensing responders. In some embodiments, information carried in the sensing-by-proxy request frame is the sensing requirement information.

In some embodiments, the sensing measurement is WLAN sensing.

In some embodiments, the sensing-by-proxy initiator is a smart phone, a wearable device, and any other device with a poor sensing measurement function, and the sensing-by-proxy responder is a wireless router, and any other device with a greater sensing measurement function.

In some embodiments, the sensing-by-proxy initiator is a personal computer (PC), a tablet PC, a smart television, a smart robot, and other terminal devices, which is not specifically limited in the embodiments of the present disclosure. The sensing-by-proxy responder is a micro base station, mobile base station, a television, and other devices, which is not specifically limited in the embodiments of the present disclosure.

In S1002, the sensing-by-proxy initiator receives a sensing-by-proxy response frame from the sensing-by-proxy responder.

In the present disclosure, after initiation of the request by the sensing-by-proxy initiator, the sensing-by-proxy responder performs the sensing measurement process on behalf of the sensing-by-proxy initiator, and reports measurement reports of the sensing measurement to the sensing-by-proxy initiator.

In summary, in the technical solutions according to the embodiments of the present disclosure, the sensing-by-proxy initiator transmits the sensing-by-proxy request frame to the sensing-by-proxy responder, such that the sensing-by-proxy responder initiates the sensing measurement based on the sensing-by-proxy request frame. Thus, the sensing-by-proxy initiator does not need to initiate the sensing measurement by itself, such that requirements on device parameters of the sensing-by-proxy initiator are lowered, and an application range of the sensing measurement is expanded.

In some embodiments, the sensing-by-proxy request frame carries information by a field (for example, a value in the field). The field is also referred to as an indication bit.

In some embodiments, as shown in FIG. 11, the sensing-by-proxy request frame is a new action frame or an action no acknowledgement (ACK) frame. In the case that a value of a Category field is 4, the frame is a public action frame. In the case that a value of a Public Action field is 53 (the value of the Public Action field is any value in the range of 51 to 255), the frame is a sensing-by-proxy request frame.

In some embodiments, the sensing-by-proxy request frame is a protected frame. In some embodiments, in the case that a value of the Category field in the sensing-by-proxy request frame is 9, the frame is a protected dual of public action frame. In the case that a value of the Public Action field is 33 (the value of the Public Action field is any value in the range of 33 to 255), the frame is a protected sensing-by-proxy request frame.

In some embodiments, the sensing-by-proxy request frame carries information indicating at least one of: (1) whether to require the sensing-by-proxy responder to obtain a sensing measurement report of the sensing measurement, (2) an accuracy requirement of a sensing measurement report, (3) a role of the sensing-by-proxy initiator in the sensing measurement, (4) whether to require sensing signal transmitters and sensing signal receivers in different sensing measurement instances to be consistent, (5) whether to require to use a protected management frame in the sensing measurement, (6) a type of a sensing measurement report, (7) a measurement periodicity of the sensing measurement, (8) a periodicity of reporting a sensing measurement report by the sensing-by-proxy responder, (9) a measurement duration of the sensing measurement, (10) information of a number of sensing participants participating in the sensing measurement, (11) device information of sensing participants specified to participate in the sensing measurement, (12) an indication of roles of at least one sensing participant participating in the sensing measurement in the sensing measurement, and (13) time information of a sensing-by-proxy requester for performing a service related to the sensing measurement.

### Whether to Require the Sensing-by-Proxy Responder to Obtain the Sensing Measurement Report of the Sensing Measurement

In some embodiments, in the case that the sensing-by-proxy initiator needs the sensing-by-proxy responder to obtain the sensing measurement reports, the sensing-by-proxy request frame transmitted to the sensing-by-proxy responder needs to carry information indicating requiring the sensing-by-proxy responder to obtain the sensing measurement reports of the sensing measurement. In some embodiments, after obtaining the sensing measurement reports, the sensing-by-proxy responder transmits the sensing measurement reports to the sensing-by-proxy initiator.

In some embodiments, the measurement reports generated by the sensing signal receivers in the sensing measurement are not transmitted directly using an IEEE 802.11 protocol frame, and is transmitted using a high layer communication protocol or an out-band method after being processed by the high layer application in the sensing signal receivers. As such, the sensing-by-proxy responder does not obtain the sensing measurement report of the sensing measurement. Thus, the sensing-by-proxy initiator does not need the sensing-by-proxy responder to obtain the sensing measurement reports. In the case that the sensing-by-proxy initiator does not need the sensing-by-proxy responder to obtain the sensing measurement reports, the sensing-by-proxy request frame transmitted to the sensing-by-proxy responder needs to carry information indicating not requiring the sensing-by-proxy responder to obtain the sensing measurement reports of the sensing measurement.

In some embodiments, as shown in FIG. 11, whether to require the sensing-by-proxy responder to obtain the sensing measurement reports of the sensing measurement is indicated by an Obtain Report indication bit. In some embodiments, in the case that a value of the Obtain Report indication bit is 1, the sensing-by-proxy responder is required to obtain the sensing measurement reports of the sensing measurement; or in the case that a value of the Obtain Report indication bit is 0, the sensing-by-proxy responder is not required to obtain the sensing measurement reports of the sensing measurement. In some embodiments, in the case that a value of the Obtain Report indication bit is 0, the sensing-by-proxy responder is required to obtain the sensing measurement reports of the sensing measurement; or in the case that a value of the Obtain Report indication bit is 1, the sensing-by-proxy responder is not required to obtain the sensing measurement reports of the sensing measurement.

In some embodiments, the sensing-by-proxy request frame implicitly indicates requiring the sensing-by-proxy responder to obtain the sensing measurement reports of the sensing measurement. For example, in the case that the sensing-by-proxy request frame does not include explicit indication information indicating whether to require the sensing-by-proxy responder to obtain the sensing measurement report of the sensing measurement, the sensing-by-proxy responder is required to obtain the sensing measurement report of the sensing measurement. In this way, only in the case that the sensing-by-proxy request frame explicitly indicates not requiring the sensing-by-proxy responder to obtain the sensing measurement report of the sensing measurement, the sensing-by-proxy responder is not required to obtain the sensing measurement report of the sensing measurement.

In some embodiments, the sensing-by-proxy request frame implicitly indicates that the sensing-by-proxy responder is not required to obtain the sensing measurement reports of the sensing measurement. For example, in the case that the sensing-by-proxy request frame does not include explicit indication information indicating whether the sensing-by-proxy responder is required to obtain the sensing measurement reports of the sensing measurement, the sensing-by-proxy responder is not required to obtain the sensing measurement reports of the sensing measurement. In this case, only in the case that the sensing-by-proxy request frame explicitly indicate requiring the sensing-by-proxy responder to obtain the sensing measurement reports of the sensing measurement, the sensing-by-proxy responder is required to obtain the sensing measurement reports of the sensing measurement.

### The Accuracy Requirement of the Sensing Measurement Result

In some embodiments, an accuracy level is determined from a plurality of accuracy levels, and is determined as the accuracy requirement of the sensing measurement result. In some embodiments, the accuracy is divided into three accuracy levels according to a high accuracy, a medium accuracy, and a low accuracy.

Alternatively, the accuracy is divided according to other forms, and the embodiments of the present disclosure do not limit division of a number of accuracy levels and the accuracy levels.

In some embodiments, as shown in FIG. 11, an Accuracy Requirement field indicates the accuracy requirement of the sensing measurement result. For example, the accuracy is divided into three accuracy levels: a high accuracy, a medium accuracy, and a low accuracy. In some embodiments, a value of the Accuracy Requirement field being 0 indicates a high accuracy, a value of the Accuracy Requirement field being 1 indicates a medium accuracy, and a value of the Accuracy Requirement field being 2 indicates a low accuracy. In some embodiments, a value of the Accuracy Requirement field being 0 indicates a low accuracy, a value of the Accuracy Requirement field being 1 indicates a medium accuracy, and a value of the Accuracy Requirement field being 2 indicates a high accuracy.

In some embodiments, the accuracy requirement of the sensing measurement result is determined based on requirements of the sensing-by-proxy initiator on the sensing measurement. For example, in a motion sensing game scenario where human movement is relatively intense, the sensing-by-proxy initiator needs to acquire a position and movement of the human body through the sensing measurement to adjust the gameplay, and thus the sensing-by-proxy initiator has a higher accuracy requirement for the sensing measurement result (for example, the above high accuracy). For example, in the case that a pet owner wants to know whether the pet cat is at home, a relative accurate report (that is, whether the pet cat is at home) is acquired based on a lower measurement accuracy, and thus the sensing-by-proxy initiator has a lower accuracy requirement for the sensing measurement result (for example, the above low accuracy).

### The Role of the Sensing-by-Proxy Initiator in the Sensing Measurement

The sensing-by-proxy initiator participates in the sensing measurement or does not participate in the sensing measurement. In some embodiments, the role of the sensing-by-proxy initiator in the sensing measurement includes any one of: a sensing signal transmitter; a sensing signal receiver; a sensing signal transmitter and a sensing signal receiver; an unspecified role; or not participating in the sensing measurement.

In some embodiments, the sensing-by-proxy initiator indicates its specific role in the sensing measurement by a sensing-by-proxy request frame. For example, the sensing-by-proxy initiator indicates its specific role in the sensing measurement is a sensing signal transmitter, a sensing signal receiver, a sensing signal transmitter and a sensing signal receiver, or does not participate in the sensing measurement, and the sensing-by-proxy responder initiates the sensing measurement setup based on the indication.

In some embodiments, in the case that the sensing-by-proxy initiator does not indicate its specific role in the sensing measurement in the sensing-by-proxy request frame or indicates that its specific role in the sensing measurement is an unspecified role, the sensing-by-proxy initiator does not specifically require its specific role in the sensing measurement, and the sensing-by-proxy responder determines a role of the sensing-by-proxy initiator in the sensing measurement. That is, the unspecified role indicates that the sensing-by-proxy initiator is not specified as the sensing signal transmitter, the sensing-by-proxy initiator is not specified as the sensing signal receiver, the sensing-by-proxy initiator is not specified as the sensing signal transmitter and the sensing signal receiver, and the sensing-by-proxy initiator is not specified as not participating in the sensing measurement, and the sensing-by-proxy responder determines that the sensing-by-proxy initiator is the sensing signal transmitter, the sensing signal receiver, the sensing signal transmitter and the sensing signal receiver, or does not participate in the sensing measurement. Not participating in the sensing measurement indicates not participating in the sensing measurement as the sensing signal transmitter and/or the sensing signal receiver.

In some embodiments, in the case that the sensing-by-proxy initiator does not participate in the sensing measurement, the sensing-by-proxy initiator is not considered as a sensing responder when the sensing-by-proxy responder initiates the sensing measurement setup.

In some embodiments, as shown in FIG. 11, a Role field indicates the role of the sensing-by-proxy initiator in the sensing measurement.

In some embodiments, in the case that a value of the Role field is 0, the sensing-by-proxy initiator is determined as the sensing signal transmitter in the sensing measurement; in the case that a value of the Role field is 1, the sensing-by-proxy initiator is determined as the sensing signal receiver in the sensing measurement; in the case that a value of the Role field is 2, the sensing-by-proxy initiator is determined as the sensing signal transmitter and the sensing signal receiver in the sensing measurement; in the case that a value of the Role field is 3, the sensing-by-proxy initiator participates in the sensing measurement and is not specified as a specific role, that is, the sensing-by-proxy responder determines the role of the sensing-by-proxy initiator in the sensing measurement; or in the case that a value of the Role field is 4, the sensing-by-proxy initiator does not participate in the sensing measurement.

In some embodiments, in the case that a value of the Role field is 4, the sensing-by-proxy initiator is determined as the sensing signal transmitter in the sensing measurement; in the case that a value of the Role field is 3, the sensing-by-proxy initiator is determined as the sensing signal receiver in the sensing measurement; in the case that a value of the Role field is 2, the sensing-by-proxy initiator is determined as the sensing signal transmitter and the sensing signal receiver in the sensing measurement; in the case that a value of the Role field is 1, the sensing-by-proxy initiator participates in the sensing measurement and is not specified as a specific role, that is, the sensing-by-proxy responder determines the role of the sensing-by-proxy initiator in the sensing measurement; or in the case that a value of the Role field is 0, the sensing-by-proxy initiator does not participate in the sensing measurement.

### Whether to Require the Sensing Signal Transmitters and the Sensing Signal Receivers in the Different Sensing Measurement Instances to be Consistent

In some embodiments, whether sensing signal transmitters and sensing signal receivers in different sensing measurement instances are consistent indicates whether sensing signal transmitters in different sensing measurement instances are the same and whether sensing signal receivers in different sensing measurement instances are the same. For example, in the case that the STA1 and the STA2 are determined as the sensing signal transmitters in each sensing measurement instance, the sensing signal transmitters in different sensing measurement instances are consistent; or in the case that the STA1, the STA3, and the STA4 are determined as the sensing signal receivers in each sensing measurement instance, the sensing signal receivers in different sensing measurement instances are consistent. For example, in the case that the STA1 and the STA2 are determined as the sensing signal transmitters in the sensing measurement instance 1, and only the STA1 is determined as the sensing signal transmitter in the sensing measurement instance 2, the sensing signal transmitters in the sensing measurement instances 1 and 2 are not consistent; or in the case that the STA1 and the STA3 are determined as the sensing signal receivers in the sensing measurement instance 1, the STA3 and the STA4 are determined as the sensing signal receivers in the sensing measurement instance 2, and the STA2 does not participate in the measurement, the sensing signal receivers in the sensing measurement instances 1 and 2 are not consistent.

In some embodiments, as shown in FIG. 11, a Fixed Sensing Signal Transmitter and Receiver (Fixed TX-RX) field indicates whether to require sensing signal transmitters and sensing signal receivers in different sensing measurement instances to be consistent. In some embodiments, in the case that a value of the Fixed TX-RX field is 1, the sensing signal transmitters and the sensing signal receivers in different sensing measurement instances are required to be consistent; or in the case that a value of the Fixed TX-RX field is 0, the sensing signal transmitters and the sensing signal receivers in different sensing measurement instances are not required to be consistent. In some embodiments, in the case that a value of the Fixed TX-RX field is 0, the sensing signal transmitters and the sensing signal receivers in different sensing measurement instances are required to be consistent; or in the case that a value of the Fixed TX-RX field is 1, the sensing signal transmitters and the sensing signal receivers in different sensing measurement instances are not required to be consistent.

Whether to require to use the protected management frame in the sensing measurement

The management frame is protected by encrypting frame information, such that the privacy and security of data transmission for the management frame are improved. In some embodiments, the sensing-by-proxy request frame indicates whether to require to encrypt the management frame in the sensing measurement.

In the wireless communication process, a data frame is generally a protected (that is, encrypted) frame, a control frame is generally not protected (that is, not encrypted), and a management frame is protected or not protected. As such, whether to protect the data frame and the control frame is generally determined, and whether to protect the management frame is not determined, and thus it is necessary for the sensing-by-proxy request frame to indicate whether to protect the management frame.

In some embodiments, as shown in FIG. 11, a Protected field indicates whether to require to use the protected management frame in the sensing measurement. In some embodiments, in the case that a value of the Protected field is 1, the protected management frame is required to be used in the sensing measurement; or in the case that a value of the Protected field is 0, the protected management frame is not required to be used in the sensing measurement. In some embodiments, in the case that a value of the Protected field is 0, the protected management frame is required to be used in the sensing measurement; or in the case that a value of the Protected field is 1, the protected management frame is not required to be used in the sensing measurement.

### The Type of the Sensing Measurement Report

In some embodiments, the type of the sensing measurement report to be acquired by the sensing participant in the sensing measurement is indicated by the sensing-by-proxy request frame.

In some embodiments, the type of the sensing measurement report includes: channel state information (CSI), CSI Amplitude only, CSI Phase only, a beam signal-to-noise ratio (SNR), an angle of arrival (AoA) of a signal, an angle of departure (AoD) of a signal, Doppler information, and the like. In some embodiments, the CSI includes channel frequency response (CFR).

In some embodiments, as shown in FIG. 11, a Measurement Report Type field indicates the type of the sensing measurement report in the measurement setup established by the request proxy. In some embodiments, in the case that a value of the Measurement Report Type field is 0, the type of the sensing measurement report is the CSI; in the case that a value of the Measurement Report Type field is 1, the type of the sensing measurement report is the beam SNR; in the case that a value of the Measurement Report Type field is 2, the type of the sensing measurement report is the CSI Amplitude only; in the case that a value of the Measurement Report Type field is 3, the type of the sensing measurement report is the CSI Phase only; in the case that a value of the Measurement Report Type field is 4, the type of the sensing measurement report is the AoA of the signal; in the case that a value of the Measurement Report Type field is 5, the type of the sensing measurement report is the AoD of the signal; in the case that a value of the Measurement Report Type field is 6, the type of the sensing measurement report is the CSI and the AoA of the signal; in the case that a value of the Measurement Report Type field is 7, the type of the sensing measurement report is the CSI and the AoD of the signal; or in the case that a value of the Measurement Report Type field is 3, the type of the sensing measurement report is the Doppler information. In some embodiments, values of the Measurement Report Type field from 9 to 255 are reserved.

The values of the Measurement Report Type field are only illustrative, and other values may be set as long as a value corresponding to each type of the sensing measurement report is different from values corresponding to other types of sensing measurement reports. For example, a value of the Measurement Report Type field being 2 indicates the CSI, and a value of the Measurement Report Type field being 1 indicates the beam SNR. For example, a value of the Measurement Report Type field being 8 indicates the CSI, and a value of the Measurement Report Type field being 15 indicates the beam SNR, and the like.

The measurement periodicity of the sensing measurement

In some embodiments, the sensing-by-proxy request frame indicates the measurement periodicity of the sensing measurement, that is, how often one sensing measurement is performed. In some embodiments, one sensing measurement is one sensing measurement instance.

The measurement periodicity is a fixed value or is set according to the demand. In some embodiments, a specific value of the measurement periodicity is set by the relevant personnel, or is automatically determined by the sensing-by-proxy initiator according to the demand, which is not limited in the embodiments of the present disclosure.

In some embodiments, in the case that the accuracy requirement of the sensing measurement result is high, the measurement periodicity is great; or in the case that the accuracy requirement of the sensing measurement result is low, the measurement periodicity is less.

In some embodiments, as shown in FIG. 11, a Measurement Periodicity field indicates the required measurement periodicity of the sensing measurement. In some embodiments, in the case that a value of the Measurement Periodicity field is 1, the measurement periodicity of the sensing measurement is 1 Hz (that is, one time per second); in the case that a value of the Measurement Periodicity field is 2, the measurement periodicity of the sensing measurement is 2 Hz (that is, two times per second); or in the case that a value of the Measurement Periodicity field is 100, the measurement periodicity of the sensing measurement is 100 Hz (that is, 100 times per second), and so on.

### The Periodicity of Reporting the Sensing Measurement Report by the Sensing-by-Proxy Responder

In some embodiments, the sensing-by-proxy initiator instructs/requests by the sensing-by-proxy request frame the periodicity of the sensing-by-proxy responder to report the sensing measurement report, that is, informs the sensing-by-proxy responder of a number of times of performing the sensing measurement after which the sensing-by-proxy initiator requests the sensing measurement report or upon which the sensing-by-proxy responder actively reports the sensing measurement report. As such, the sensing-by-proxy responder allocates and releases appropriate cache resources based on the periodicity indicated/requested by the sensing-by-proxy initiator.

In some embodiments, as shown in FIG. 11, a Report Periodicity field indicates the periodicity of reporting the sensing measurement report requested to the sensing-by-proxy responder. In some embodiments, in the case that a value of the Report Periodicity field is 1, the sensing measurement report is requested in each sensing measurement instance; in the case that a value of the Report Periodicity field is 2, the sensing measurement report is requested in each two sensing measurement instances; or in the case that a value of the Report Periodicity field is 3, the sensing measurement report is requested in each three sensing measurement instances.

In some embodiments, for gesture recognition or heartbeat detection, a time interval between sensing measurement instances is relatively short, and the sensing-by-proxy initiator may not be able to contend for a transmission opportunity to request the sensing-by-proxy responder to transmit the sensing measurement report after each sensing measurement instance, and thus the sensing-by-proxy responder needs to cache the sensing measurement report. A size of a single sensing measurement report ranges from several hundred bytes to tens of thousands of bytes, but the cache capacity is limited, such that the sensing-by-proxy initiator needs to acquire cached data of the sensing-by-proxy responder in time. In addition, the sensing-by-proxy initiator also needs to obtain the sensing measurement report in time to generate the final sensing result in time. Thus, the periodicity of reporting the sensing measurement report requested to the sensing-by-proxy responder is indicated by the sensing-by-proxy request frame to ensure the timeliness of the reported sensing measurement report on the premise of smooth reporting of the sensing measurement report.

### The Measurement Duration of the Sensing Measurement

In some embodiments, the sensing-by-proxy request frame indicates the measurement duration of the sensing measurement, that is, indicates that a duration after which the sensing measurement is ended. In some embodiments, the measurement duration of the sensing measurement is used to implicitly instruct the sensing measurement participant to terminate the measurement setup of the sensing measurement. After determining the measurement duration of the sensing measurement, the sensing measurement participant does not need explicit indication information of terminating the sensing measurement after the start time of the sensing measurement, and automatically terminates the sensing measurement after reach of the measurement duration of the sensing measurement, so to implicitly instruct the sensing measurement participant to terminate the measurement setup of the sensing measurement and save signaling overhead. For example, after reach of the measurement duration of the sensing measurement, the sensing transmitter terminates transmitting the sensing signal, and terminates the measurement setup related to the transmission of the sensing signal. For example, after reach of the measurement duration of the sensing measurement, the sensing receiver stops receiving the sensing signal, and terminates the measurement setup related to reception of the sensing signal.

In some embodiments, the sensing measurement participant terminating the measurement setup of the sensing measurement includes that the sensing measurement participant releases resources related to the sensing measurement. In the sensing measurement process, partial resources of the sensing measurement participant, for example, cache space, transmission channels, and the like, are occupied by the sensing measurement; after ending of the measurement duration of the sensing measurement, the sensing measurement participant frees up resources occupied by the sensing measurement to improve a quality and/or progress of other services being performed; or, the sensing measurement participant frees up resources occupied by the sensing measurement to undertake and perform other services, for example, perform other sensing measurements.

In some embodiments, the sensing measurement participant releasing resources related to the sensing measurement includes at least one of: the sensing measurement participant deleting a measurement report of the sensing measurement; or the sensing measurement participant deleting measurement configuration information of the sensing measurement.

In some embodiments, in the sensing measurement process, the cache space of the sensing measurement participant caches data related to the sensing measurement and received and/or generated by the sensing measurement participant, for example, the measurement report of the sensing measurement, the measurement configuration information, and the like; after ending of the measurement duration of the sensing measurement, the sensing measurement participant deletes the data related to the sensing measurement, received and/or generated by the sensing measurement participant, and cached in the cache space, such that the cache space is released to cache data of other services.

In some embodiments, the measurement configuration information deleted by the sensing measurement participant includes, but is not limited to at least one of: a measurement setup ID of the sensing measurement, measurement start time of the sensing measurement, the accuracy requirement of the sensing measurement result, the role of the sensing-by-proxy initiator in the sensing measurement, whether to require the sensing signal transmitters and the sensing signal receivers in different sensing measurement instances to be consistent, whether to require to use the protected management frame in the sensing measurement, the type of the sensing measurement report, the measurement periodicity of the sensing measurement, the periodicity of reporting the sensing measurement report by the sensing-by-proxy responder, the measurement duration of the sensing measurement, the minimum number of sensing participants participating in the sensing measurement, or the device information of sensing participants specified to participate in the sensing measurement.

In some embodiments, as shown in FIG. 11, a Measurement Duration field indicates a required measurement duration of the sensing measurement, that is, a duration after which the corresponding sensing process is terminated. In some embodiments, the duration is measured in minutes. In the case that a value of the Measurement Duration field is 1, the measurement duration of the sensing measurement is one minute; in the case that a value of the Measurement Duration field is 2, the measurement duration of the sensing measurement is two minutes, and so on. In some embodiments, the duration is measured in minutes. In the case that a value of the Measurement Duration field is 1, the measurement duration of the sensing measurement is one minute; in the case that a value of the Measurement Duration field is 2, the measurement duration of the sensing measurement is two minutes; in the case that a value of the Measurement Duration field is 3, the measurement duration of the sensing measurement is four minutes; in the case that a value of the Measurement Duration field is 4, the measurement duration of the sensing measurement is eight minutes; or in the case that a value of the Measurement Duration field is 5, the measurement duration of the sensing measurement is 16 minutes, and the like, which is not specifically limited in the embodiments of the present disclosure.

### The Information of the Number of Sensing Participants Participating in the Sensing Measurement

In some embodiments, the more the sensing participants, the more accurate the sensing measurement result. Thus, the sensing-by-proxy initiator indicates a minimum number of sensing participants participating in the sensing measurement by the sensing-by-proxy request frame based on the accuracy requirement of the sensing measurement result, such that the accuracy of the sensing measurement result is ensured.

In some embodiments, as shown in FIG. 11, a Min Sensing Responders Number field indicates a minimum number of sensing participants participating in the sensing measurement.

In some embodiments, the information of the number of sensing participants participating in the sensing measurement includes any one of: a minimum number of sensing participants participating in the sensing measurement; or a specific number of sensing participants participating in the sensing measurement.

The device information of the sensing participants specified to participate in the sensing measurement

In some embodiments, the device information of sensing participants affects the accuracy of the sensing measurement result and the efficiency of the sensing measurement, and thus the sensing-by-proxy request frame indicates device information of part or all of the sensing participants.

In some embodiments, the device information includes a MAC address, a role of the sensing participant in the sensing measurement, whether to use a protected management frame in the sensing process, and the like. In some embodiments, the device information further includes a device model, a number of antennas, and the like.

In some embodiments, as shown in FIG. 11, a Required Sensing Responders List field indicates the device information of specified sensing participants.

### The Indication of the Roles of at Least One Sensing Participant Participating in the Sensing Measurement in the Sensing Measurement

In some embodiments, the sensing-by-proxy initiator needs the sensing participant to perform bidirectional measurement (that is, participate in the measurement as the sensing transmitter and the sensing receiver) to acquire a higher measurement accuracy and more measurement reports. In some embodiments, the sensing-by-proxy initiator only needs to the sensing participant to perform one-way measurement to reduce the network load in the case of meeting the measurement accuracy requirement. Thus, the sensing-by-proxy initiator needs to indicate the sensing-by-proxy responder of the role of the sensing participant, for example, a uniform role or separate roles. In some embodiments, the sensing-by-proxy initiator does not know specific sensing capabilities of various sensing participants in the system, and thus the sensing-by-proxy responder determines the roles of various sensing participants.

In some embodiments, the indication of the roles of at least one sensing participant participating in the sensing measurement in the sensing measurement includes any one of following cases.

### 12.1. Roles of the at Least One Sensing Participant in the Sensing Measurement are Determined by the Sensing-by-Proxy Responder.

In some embodiments, the sensing-by-proxy request frame instructs the sensing-by-proxy responder to determine the role of the sensing participant in the sensing measurement, and the sensing-by-proxy initiator does not indicate the role of the sensing participant in the sensing measurement.

### 12.2. The at Least One Sensing Participant is Determined to Play a Same Role in the Sensing Measurement.

In some embodiments, the sensing-by-proxy initiator indicates, by the sensing-by-proxy request frame, that roles of all sensing participants participating in the sensing measurement are the same. For example, all sensing participants are the sensing receiver. Alternatively, all sensing participants are the sensing transmitter. Alternatively, all sensing participants are both the sensing receivers and the sensing transmitters.

### 12.3. Roles of Various Sensing Participants in the Sensing Measurement are Determined.

In some embodiments, the sensing-by-proxy initiator indicates, by the sensing-by-proxy request frame, separate roles of sensing participants in the sensing measurement for all sensing participants.

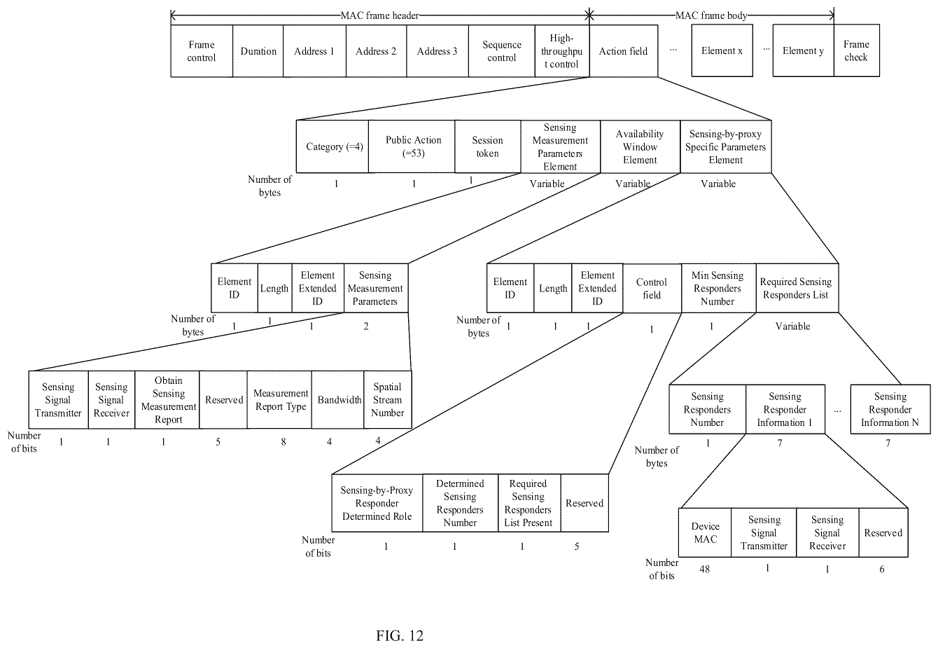

In some embodiments, as shown in FIG. 12, the sensing-by-proxy request frame further includes: a Sensing Measurement Parameters Element field, indicating a common measurement configuration effective for at least one sensing participant; an Availability Window Element field, indicating time information of the sensing-by-proxy requester for performing a service related to the sensing measurement; an sensing-by-proxy (SBP) Specific Parameters Element field, indicating information related to establish the sensing measurement; a Minimum Sensing Participants Number field, indicating a specific number or a minimum number of sensing participants participating in the sensing measurement; a Sensing-by-Proxy Responder Determined Role field, indicating whether roles of at least one sensing participant in the sensing measurement are determined by the sensing-by-proxy responder; and a Determined Sensing Responder Number field, indicating that the number of sensing participants participating in the sensing measurement indicated in the Minimum Sensing Participants Number field is a specific number or a minimum number of sensing participants participating in the sensing measurement.

In some embodiments, as shown in FIG. 12, in the case that an indication of a “Required Sensing Responders List Present” field is No:

the “Required Sensing Responders List” field is not present, the sensing-by-proxy initiator does not indicate specific device information of sensing responder participating in the sensing measurement, and the sensing-by-proxy responder determines which devices participate in the sensing measurement;

the sensing measurement is established between the sensing-by-proxy responder and a number, consistent with a value indicated by the “Min Sensing Responders Number” field, of sensing responders in the case that a “Determined Responder Number” field indicates Yes; and the sensing measurement is established between the sensing-by-proxy responder and at least a number, consistent with a value indicated by the “Min Sensing Responders Number” field, of sensing responders in the case that a “Determined Responder Number” field indicates No;

the sensing-by-proxy responder skips a “Sensing Signal Transmitter” field and a “Sensing Signal Receiver” field in a “Sensing Measurement Parameters” field in the case that a “Sensing-by-Proxy Responder Determined Role” field indicates Yes, and the sensing-by-proxy responder determines the roles of various sensing responders based on capabilities of the various sensing responders; and

the sensing-by-proxy responder determines, based on the “Sensing Signal Transmitter” field and the “Sensing Signal Receiver” field in the “Sensing Measurement Parameters” field, that the roles of various sensing responders are indicated by the two fields in the case that a “Sensing-by-Proxy Responder Determined Role” field indicates No. That is, the roles of various sensing responders are the same, for example, all the sensing responders are sensing signal transmitters, all the sensing responders are sensing signal receivers, or all the sensing responders have the roles of both the sensing signal transmitter and the sensing signal receiver.

In some embodiments, as shown in FIG. 12, in the case that an indication of a “Required Sensing Responders List Present” field is Yes:
the “Required Sensing Responders List” field is present, the sensing-by-proxy initiator indicates specific device information of sensing participants participating in the sensing measurement, the sensing-by-proxy responder determines which devices participate in the sensing measurement and skips a “Determined Responder Number” field and a “Min Sensing Responders Number” field;
the sensing-by-proxy responder skips a “Sensing Signal Transmitter” field and a “Sensing Signal Receiver” field in a “Sensing Responder Information” field in the case that a “Sensing-by-Proxy Responder Determined Role” field indicates Yes, and the sensing-by-proxy responder determines the roles of various sensing responders based on capabilities of the various sensing responders; and
the sensing-by-proxy responder determines, based on the “Sensing Signal Transmitter” field and the “Sensing Signal Receiver” field in the “Sensing Responder Information” field, the roles of corresponding sensing responders in the case that a “Sensing-by-Proxy Responder Determined Role” field indicates No. That is, the roles of various sensing responders may be the same or different.

The sensing responder may be replaced with the sensing participant in the above description.

### The Time Information of the Sensing-by-Proxy Requester for Performing the Service Related to the Sensing Measurement

In some embodiments, the time information of the sensing-by-proxy requester for performing the service related to the sensing measurement includes at least one of: a duration of participating in the sensing measurement by the sensing-by-proxy initiator; a duration of receiving the sensing measurement report by the sensing-by-proxy initiator; or a periodicity for the sensing-by-proxy initiator to request the sensing-by-proxy responder to perform the sensing measurement on behalf of the sensing-by-proxy initiator.

In some embodiments, as shown in FIG. 11, the sensing-by-proxy request frame further includes: a Sensing Requirement Information field; a Control field; a Measurement Periodicity Present indication bit; a Report Periodicity Present indication bit; a Measurement Duration Present indication bit; a Min Sensing Responders Number Present indication bit; and a Required Sensing Responders List Present indication bit.

The Sensing Requirement Information field indicates a requirement on measurement setup requested to be established on its behalf.

The Control field indicates whether one or more subsequent fields (for example, a Measurement Periodicity field, a Report Periodicity field, a Measurement Duration field, a Min Sensing Responders Number field, a Required Sensing Responders List field, and the like) are present.

The Measurement Periodicity Present indication bit indicates whether the subsequent Measurement Periodicity field is present. In some embodiments, in the case that a value of the Measurement Periodicity Present indication bit is 1, the subsequent Measurement Periodicity field is present; or in the case that a value of the Measurement Periodicity Present indication bit is 0, the subsequent Measurement Periodicity field is not present. In some embodiments, in the case that a value of the Measurement Periodicity Present indication bit is 0, the subsequent Measurement Periodicity field is present; or in the case that a value of the Measurement Periodicity Present indication bit is 1, the subsequent Measurement Periodicity field is not present.

The Report Periodicity Present indication bit indicates whether the subsequent Report Periodicity field is present. In some embodiments, in the case that a value of the Report Periodicity Present indication bit is 1, the subsequent Report Periodicity field is present; or in the case that a value of the Report Periodicity Present indication bit is 0, the subsequent Report Periodicity field is not present. In some embodiments, in the case that a value of the Report Periodicity Present indication bit is 0, the subsequent Report Periodicity field is present; or in the case that a value of the Report Periodicity Present indication bit is 1, the subsequent Report Periodicity field is not present.

The Measurement Duration Present indication bit indicates whether the subsequent Measurement Duration field is present. In some embodiments, in the case that a value of the Measurement Duration Present indication bit is 1, the subsequent Measurement Duration field is present; or in the case that a value of the Measurement Duration Present indication bit is 0, the subsequent Measurement Duration field is not present. In some embodiments, in the case that a value of the Measurement Duration Present indication bit is 0, the subsequent Measurement Duration field is present; or in the case that a value of the Measurement Duration Present indication bit is 1, the subsequent Measurement Duration field is not present.

The Min Sensing Responders Number Present indication bit indicates whether the subsequent Min Sensing Responders Number field is present. In some embodiments, in the case that a value of the Min Sensing Responders Number Present indication bit is 1, the subsequent Min Sensing Responders Number field is present; or in the case that a value of the Min Sensing Responders Number Present indication bit is 0, the subsequent Min Sensing Responders Number field is not present. In some embodiments, in the case that a value of the Min Sensing Responders Number Present indication bit is 0, the subsequent Min Sensing Responders Number field is present; or in the case that a value of the Min Sensing Responders Number Present indication bit is 1, the subsequent Min Sensing Responders Number field is not present.

The Required Sensing Responders List Present indication bit indicates whether the subsequent Required Sensing Responders List field is present. In some embodiments, in the case that a value of the Required Sensing Responders List Present indication bit is 1, the subsequent Required Sensing Responders List field is present; or in the case that a value of the Required Sensing Responders List Present indication bit is 0, the subsequent Required Sensing Responders List field is not present. In some embodiments, in the case that a value of the Min Sensing Responders Number Present indication bit is 0, the subsequent Required Sensing Responders List field is present; or in the case that a value of the Required Sensing Responders List Present indication bit is 1, the subsequent Required Sensing Responders List field is not present.

In some embodiments, the sensing-by-proxy response frame carries information by following fields (for example, values of the fields).

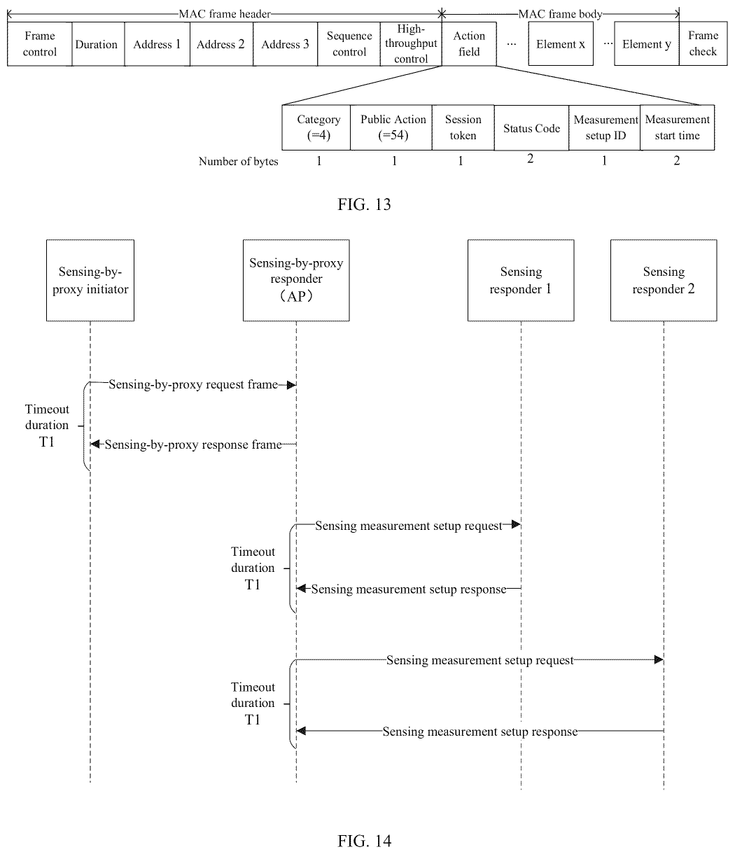

In some embodiments, as shown in FIG. 13, the sensing-by-proxy response frame is an action frame or an action no ack frame. In the case that a value of a Category field is 4, the frame is a public action frame. In the case that a value of a Public Action field is 54 (the value of the Public Action field is any value from 51 to 255), the frame is a sensing-by-proxy response frame.

In some embodiments, a protected sensing-by-proxy response frame is an action frame or an action no ack frame. In the case that a value of a Category field is 9, the frame is a protected dual of public action frame. In the case that a value of a Public Action field is 34 (the value of the Public Action field is any value from 33 to 255), the frame is a protected sensing-by-proxy response frame.

In some embodiments, the sensing-by-proxy response frame carries at least one of: a measurement setup ID of the sensing measurement, or measurement start time of the sensing measurement.

In some embodiments, the sensing-by-proxy response frame includes a Measurement Setup ID field indicating a measurement setup ID of a to-be-set-up sensing measurement.

In some embodiments, the sensing-by-proxy response frame includes a Measurement Start Time field indicating measurement start time of the sensing measurement, that is, a start time of a first sensing measurement instance. In some embodiments, as the sensing-by-proxy initiator does not participate in the sensing measurement, a start time of the sensing measurement instance is not acquired, and a sensing measurement report is not requested to be reported based on a specified periodicity, the sensing-by-proxy responder indicates the measurement start time in the sensing-by-proxy response frame.

In some embodiments, the measurement start time is set as a value of a partial timing synchronization function (TSF) of target time, or an offset of target time against current time. The TSF represents the timing synchronization function, and the partial TSF represents truncated data of a value of synchronization time. For example, the most significant 38 bits and the least significant 10 bits are removed from 64 bits of a TSF timer.

In some embodiments, the sensing-by-proxy response frame further includes a Status Code field indicating whether a sensing-by-proxy request is successful. In some embodiments, in the case that a value of the Status Code field is 0, the sensing-by-proxy request of the sensing-by-proxy initiator is successful, that is, the sensing-by-proxy responder accepts the sensing-by-proxy request initiated by the sensing-by-proxy initiator; in the case that a value of the Status Code field is 1, the sensing-by-proxy request of the sensing-by-proxy initiator fails, that is, the sensing-by-proxy responder rejects the sensing-by-proxy request without a reason; or in the case that a value of the Status Code field is 113, the sensing-by-proxy request is rejected due to an insufficient number of sensing participants (any value from 113 to 65535 may indicate that the sensing-by-proxy request is rejected due to an insufficient number of sensing participants). Values of the field is only illustrative, and other values may be set as long as a value of each Status Code field is different from values of other Status Code fields.

In some embodiments, in the case that the Status Code field indicates that the sensing-by-proxy request of the sensing-by-proxy initiator is successful, the Measurement Setup ID field is present. Otherwise, the Measurement Setup ID field is not present.

In some embodiments, in the case that the Status Code field indicates that the sensing-by-proxy request of the sensing-by-proxy initiator is successful, the Measurement Start Time field is present. Otherwise, the Measurement Start Time field is not present.

In some embodiments, the sensing-by-proxy response frame is transmitted by the sensing-by-proxy responder prior to initiation of the measurement setup of the sensing measurement.

In some embodiments, as shown in FIG. 14, the sensing-by-proxy initiator requests the sensing-by-proxy responder to establish measurement (for example, the WLAN sensing) on behalf of the sensing-by-proxy initiator, and the sensing-by-proxy responder transmits the sensing-by-proxy response frame to the sensing-by-proxy initiator prior to initiation of the sensing measurement setup. The sensing-by-proxy responder establishes the sensing measurement setup with associated STAs. In some embodiments, a device associated with the sensing-by-proxy responder is identified by an associated identifier.

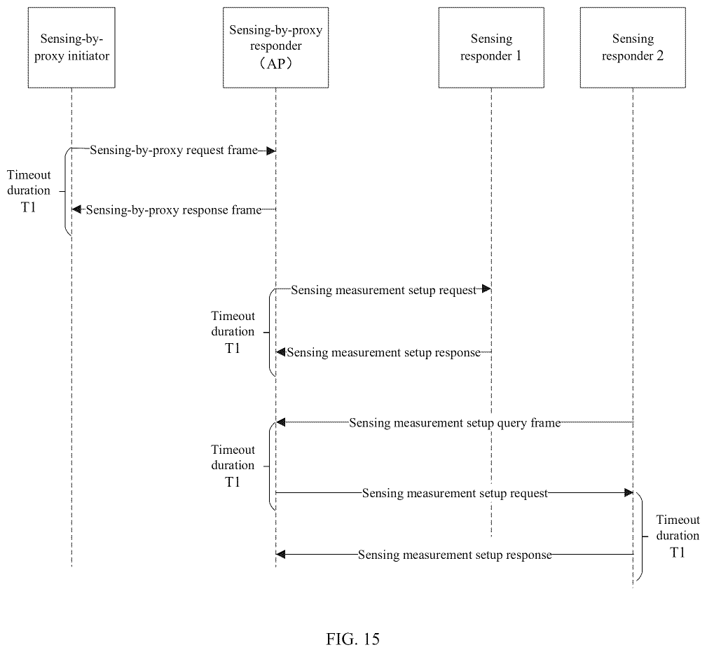

In some embodiments, as shown in FIG. 15, the sensing-by-proxy initiator requests the sensing-by-proxy responder to establish measurement (for example, the WLAN sensing) on behalf of the sensing-by-proxy initiator, and the sensing-by-proxy responder transmits the sensing-by-proxy response frame to the sensing-by-proxy initiator prior to initiation of the sensing measurement setup. The sensing-by-proxy responder establishes the sensing measurement setup with an associated STA and/or an unassociated STA. For example, a sensing responder 2 is an unassociated STA, and needs to first transmit a sensing measurement setup query frame (MS query) to the sensing-by-proxy responder prior to the sensing-by-proxy responder establishing the sensing measurement setup with the sensing responder 2.

The associated STA indicates an STA that has a communication link (for example, network connection) with the sensing-by-proxy responder, and the unassociated STA indicates an STA that does not have a communication link with the sensing-by-proxy responder. For example, in the case that the sensing-by-proxy responder is a wireless router, the associated STA is a smart TV, a sensing measurement sensor, a smart mobile phone, and any other device having a network connection with the wireless router, and the associated STA of the wireless router is another wireless router that has a communication link with the wireless router.

In some embodiments, the sensing-by-proxy response frame is transmitted by the sensing-by-proxy responder after completion of the measurement setup of the sensing measurement.

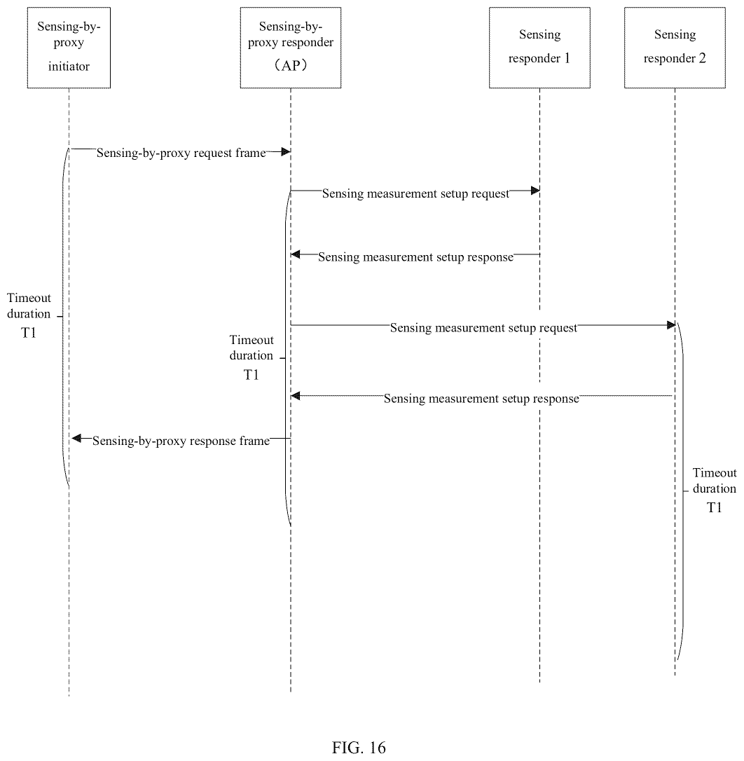

In some embodiments, as shown in FIG. 16, the sensing-by-proxy initiator requests the sensing-by-proxy responder to establish measurement (for example, the WLAN sensing) on behalf of the sensing-by-proxy initiator, and the sensing-by-proxy responder transmits the sensing-by-proxy response frame to the sensing-by-proxy initiator after completion of the sensing measurement setup.

In some embodiments, the sensing-by-proxy response frame is transmitted by the sensing-by-proxy responder after initiation of the measurement setup of the sensing measurement.

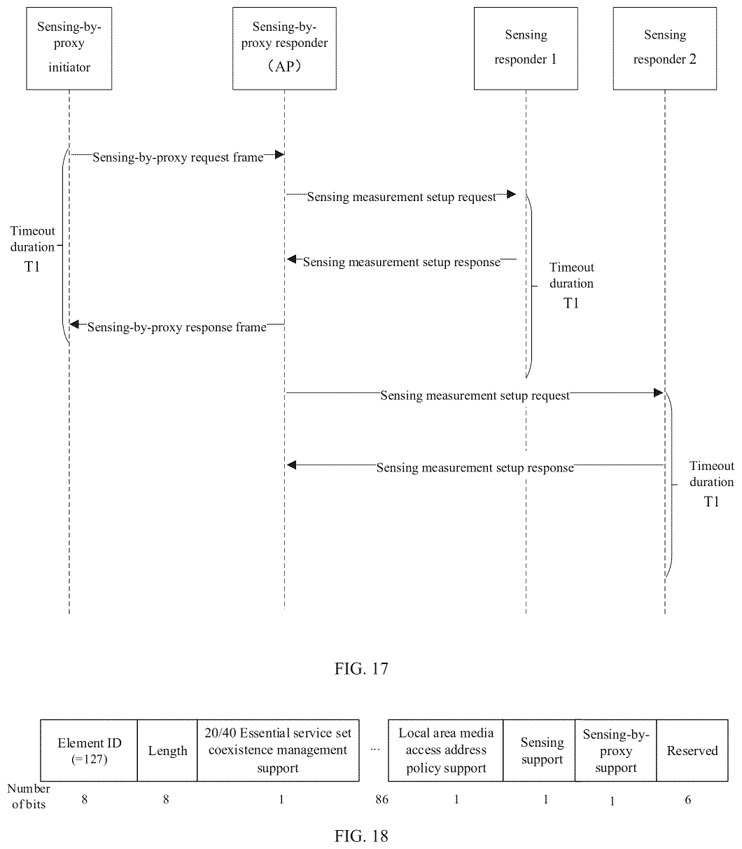

In some embodiments, as shown in FIG. 17, the sensing-by-proxy initiator requests the sensing-by-proxy responder to establish measurement (for example, the WLAN sensing) on behalf of the sensing-by-proxy initiator, and the sensing-by-proxy responder transmits the sensing-by-proxy response frame to the sensing-by-proxy initiator after initiation of the sensing measurement setup.

In some embodiments, a duration between a transmission time of the sensing-by-proxy request frame and a reception time of the sensing-by-proxy response frame is less than or equal to a first interval.

In some embodiments, the first interval is a timeout duration. In some embodiments, the timeout duration is a predefined timeout duration. As shown in FIG. 14 to FIG. 17, a duration between a transmission time of the sensing-by-proxy request frame and a reception time of the sensing-by-proxy response frame is less than or equal to the timeout duration T1.

In some embodiments, as shown in FIG. 14 to FIG. 17, for a sensing measurement setup request and a sensing measurement setup response corresponding to the sensing measurement setup request, a duration between a transmission time of the sensing measurement setup request and a reception time of the sensing measurement setup response is also less than or equal to the timeout duration T1. That is, a timeout duration corresponding to the sensing measurement setup request and the sensing measurement setup response is equal to the timeout duration corresponding to the sensing-by-proxy request frame and the sensing-by-proxy response frame.

In some embodiments, as shown in FIG. 15, the timeout duration corresponding to the sensing measurement setup request and the sensing measurement setup response, the timeout duration corresponding to a sensing measurement setup query frame and the sensing measurement setup request, the timeout duration corresponding to the sensing-by-proxy request frame and the sensing-by-proxy response frame are equal.

In some embodiments, the sensing-by-proxy initiator transmits sensing capability information to the sensing-by-proxy responder, and/or, the sensing-by-proxy initiator receives sensing capability information from the sensing-by-proxy responder.

In a capability exchange (that is, a capability interaction) phase, a device indicates its essential sensing capabilities in the sensing capability information (for example, by an Extended Capabilities Element field shown in FIG. 18).

In some embodiments, as shown in FIG. 18, the sensing capability information carries at least one of following pieces of information: support of sensing-by-proxy measurement, or a maximum number of supported measurement setups that are run concurrently. For a non-AP STA, support of the sensing-by-proxy measurement indicates that the device supports to be a sensing-by-proxy initiator. For an AP STA, support of the sensing-by-proxy measurement indicates that the device supports to be a sensing-by-proxy responder.

In some embodiments, as shown in FIG. 18, the sensing capability information further carries information indicating SBP Support of the device (for example, the WLAN sensing). For example, a value of a Sensing-by-proxy Measurement Support field in the sensing capability information is set as a first value (the first value indicates support of the sensing-by-proxy measurement) to indicate that the sensing-by-proxy initiator or the sensing-by-proxy responder supports the sensing-by-proxy measurement.

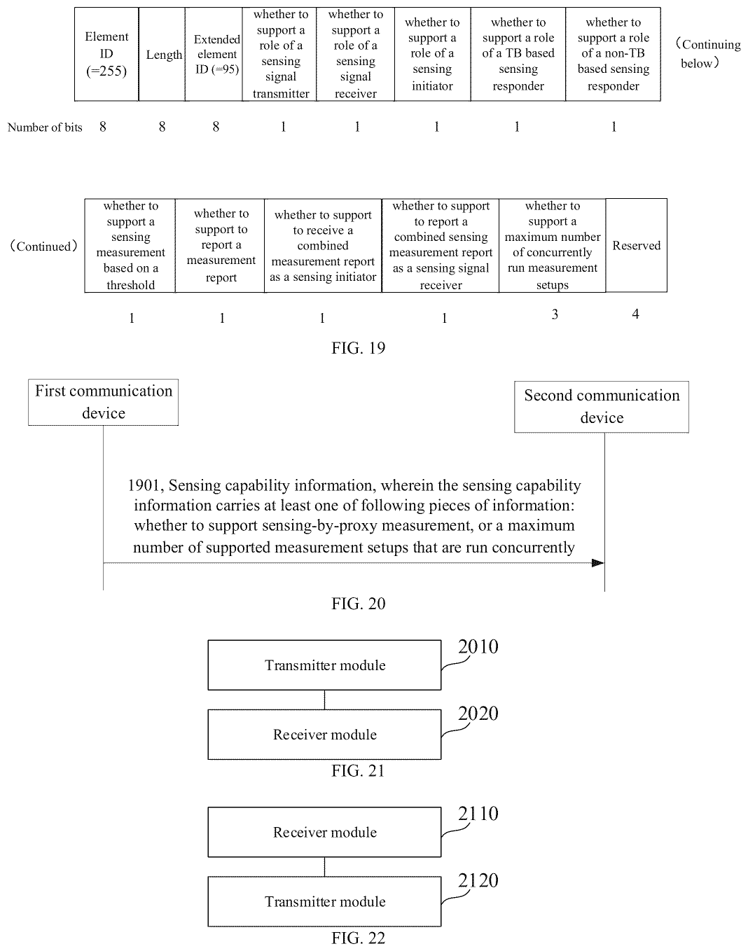

In some embodiments, in a capability exchange (that is, a capability interaction) phase, a device indicates its detailed sensing capabilities in a Sensing Capabilities Element field. As shown in FIG. 19, the Sensing Capabilities Element field indicates whether the device supports the role of the sensing signal transmitter, and/or supports the role of the sensing signal receiver, and/or supports the role of the sensing initiator, and/or supports the role of the TB based sensing responder, and/or supports the role of the non-TB based sensing responder, and/or supports the sensing measurement based on a threshold, and/or supports to report the measurement report, and/or supports to receive a combined sensing measurement report as a sensing initiator, and/or supports to report a combined sensing measurement report as a sensing signal receiver, and/or the maximum number of concurrent measurement setups.

A maximum number of concurrent measurement setups varies at different STAs. For example, an AP supports to four different concurrent measurement setups, and the STA1 only supports two measurement setups, such that only two different concurrent measurement setups are established between the AP and the STA1. For example, an AP supports eight different concurrent measurement setups, and the STA2 only supports one measurement setup, such that only one measurement setup is established between the AP and the STA2.

In some embodiments, the number of concurrent measurement setups at the STA is limited by capacities of the device, user setup, storage resources, or power. In some embodiments, in the case that the AP and/or the STA2 should not try to establish new and different measurement setup with each other in the case that the number of measurement setups in operation reaches a limited number. For example, the AP should not instruct to establish new and different measurement setup with the STA2 in the TF poll in the measurement instance, and the STA2 should also not transmit the measurement setup query frame and/or the measurement setup request frame to try to establish new and different measurement setup with the AP.

In some embodiments, the Extended Capabilities Element field is carried in a beacon frame, and/or a probe request frame, and/or a probe response frame, and/or an association request frame, and/or an association response frame, and/or a reassociation request frame, and/or a reassociation response frame.

In some embodiments, the Sensing Capabilities Element field is carried in a beacon frame, and/or a probe request frame, and/or a probe response frame, and/or an association request frame, and/or an association response frame, and/or a reassociation request frame, and/or a reassociation response frame, and/or a measurement setup query frame.

The technical solutions according to the present disclosure are described above from interaction of the sensing-by-proxy initiator and the sensing-by-proxy responder. The above processes performed by the sensing-by-proxy initiator are implemented as a sensing measurement method applicable to the sensing-by-proxy initiator, and the above processes performed by the sensing-by-proxy responder are implemented as a sensing measurement method applicable to the sensing-by-proxy responder.

In some embodiments, as shown in FIG. 20, a capability interaction method is further provided according to some embodiments of the present disclosure. The method includes a following process (1901).

In S1901, sensing capability information is transmitted to a second communication device, wherein the sensing capability information carries information indicating at least one of: whether to support sensing-by-proxy measurement, or a maximum number of supported measurement setups that are run concurrently.

In some embodiments, as shown in FIG. 18, a first communication device indicates, by a “Sensing-by-Proxy Support” field in the sensing capability information, whether the first communication device supports sensing-by-proxy measurement. For example, in the case that a value of the “Sensing-by-Proxy Support” field is 1, the first communication device supports the sensing-by-proxy measurement; or in the case that a value of the “Sensing-by-Proxy Support” field is 0, the first communication device does not support the sensing-by-proxy measurement.

For a non-AP STA, whether to support the sensing-by-proxy measurement indicates whether the device supports to be a sensing-by-proxy initiator. For an AP STA, whether to support the sensing-by-proxy measurement indicates whether the device supports to be a sensing-by-proxy responder.

For description of the sensing capability information, reference may be made to above description, which is not described again herein.

FIG. 21 is a block diagram of a sensing measurement apparatus according to some embodiments of the present disclosure. The apparatus includes a transmitter module 2010 and a receiver module 2020.

The transmitter module 2010 is configured to transmit a sensing-by-proxy request frame to a sensing-by-proxy responder, wherein the sensing-by-proxy request frame is for requesting the sensing-by-proxy responder to perform sensing measurement on behalf of the apparatus.

The receiver module 2020 is configured to receive a sensing-by-proxy response frame from the sensing-by-proxy responder.

In some embodiments, the sensing-by-proxy request frame carries information indicating at least one of: whether to require the sensing-by-proxy responder to obtain a sensing measurement report of the sensing measurement; an accuracy requirement of a sensing measurement result; a role of a sensing-by-proxy initiator in the sensing measurement; whether to require sensing signal transmitters and sensing signal receivers in different sensing measurement instances to be consistent; whether to require to use a protected management frame in the sensing measurement; a type of a sensing measurement report; a measurement periodicity of the sensing measurement; a periodicity of reporting a sensing measurement report by the sensing-by-proxy responder; a measurement duration of the sensing measurement; information of a number of sensing participants participating in the sensing measurement; device information of sensing participants specified to participate in the sensing measurement; an indication of roles of at least one sensing participant participating in the sensing measurement in the sensing measurement; or time information of a sensing-by-proxy requester for performing a service related to the sensing measurement.

In some embodiments, the information of the number of sensing participants participating in the sensing measurement includes any one of: a minimum number of sensing participants participating in the sensing measurement; or a specific number of sensing participants participating in the sensing measurement.

In some embodiments, the indication of the roles of at least one sensing participant participating in the sensing measurement in the sensing measurement includes any one of: an indication, by the sensing-by-proxy responder, of the roles of the at least one sensing participant in the sensing measurement; an indication that the at least one sensing participant plays a same role in the sensing measurement; or an indication of roles of various sensing participants in the sensing measurement.

In some embodiments, the time information of the sensing-by-proxy requester for performing the service related to the sensing measurement includes at least one of: a duration of participating in the sensing measurement by the sensing-by-proxy initiator; a duration of receiving the sensing measurement report by the sensing-by-proxy initiator; or a periodicity for the sensing-by-proxy initiator to request the sensing-by-proxy responder to perform the sensing measurement on behalf of the sensing-by-proxy initiator.

In some embodiments, the sensing-by-proxy request frame includes at least one of: a Sensing Measurement Parameters Element field, indicating a common measurement configuration effective for at least one sensing participant; an Availability Window Element field, indicating time information of a sensing-by-proxy requester for performing a service related to the sensing measurement; an SBP Specific Parameters Element field, indicating information related to establishing the sensing measurement; a Minimum Sensing Participants Number field, indicating a specific number or a minimum number of sensing participants participating in the sensing measurement; a Sensing-by-Proxy Responder Determined Role field, indicating whether roles of at least one sensing participant in the sensing measurement are indicated by the sensing-by-proxy responder; or a Determined Sensing Responder Number field, indicating that a number of sensing participants participating in the sensing measurement indicated in a Minimum Sensing Participants Number field is a specific number or a minimum number of sensing participants participating in the sensing measurement.

In some embodiments, the role of the sensing-by-proxy initiator in the sensing measurement includes any one of: a sensing signal transmitter; a sensing signal receiver; a sensing signal transmitter and a sensing signal receiver; an unspecified role; or not participating in the sensing measurement.

In some embodiments, the sensing-by-proxy response frame carries at least one of following pieces of information: a measurement setup identifier of the sensing measurement; or measurement start time of the sensing measurement.

In some embodiments, the sensing-by-proxy response frame is transmitted by the sensing-by-proxy responder prior to initiation of a measurement setup of the sensing measurement; the sensing-by-proxy response frame is transmitted by the sensing-by-proxy responder after initiation of a measurement setup of the sensing measurement; or the sensing-by-proxy response frame is transmitted by the sensing-by-proxy responder after completion of a measurement setup of the sensing measurement.

In some embodiments, a duration between a transmission time of the sensing-by-proxy request frame and a reception time of the sensing-by-proxy response frame is less than or equal to a first interval.

In some embodiments, the transmitter module 2010 is further configured to transmit sensing capability information to the sensing-by-proxy responder; and the receiver module 2020 is further configured to receive sensing capability information from the sensing-by-proxy responder.

In some embodiments, the sensing capability information carries information indicating at least one of: support of sensing-by-proxy measurement; or a maximum number of supported measurement setups that are run concurrently.

In summary, in the technical solutions according to the embodiments of the present disclosure, the sensing-by-proxy initiator transmits the sensing-by-proxy request frame to the sensing-by-proxy responder, such that the sensing-by-proxy responder initiates the sensing measurement based on the sensing-by-proxy request frame. Thus, the sensing-by-proxy initiator does not need to initiate the sensing measurement by itself, such that requirements on device parameters of the sensing-by-proxy initiator are lowered, and an application range of the sensing measurement is expanded.

FIG. 22 is a block diagram of a WLAN sensing apparatus according to some embodiments of the present disclosure. The apparatus includes a receiver module 2110 and a transmitter module 2120.

The receiver module 2110 is configured to receive a sensing-by-proxy request frame from a sensing-by-proxy initiator, wherein the sensing-by-proxy request frame is for requesting a sensing-by-proxy responder to perform sensing measurement on behalf of the sensing-by-proxy initiator.

The transmitter module 2120 is configured to transmit a sensing-by-proxy response frame to the sensing-by-proxy initiator.

In some embodiments, the sensing-by-proxy request frame carries information indicating at least one of: whether to require the sensing-by-proxy responder to obtain a sensing measurement report of the sensing measurement; an accuracy requirement of a sensing measurement result; a role of the sensing-by-proxy initiator in the sensing measurement; whether to require sensing signal transmitters and sensing signal receivers in different sensing measurement instances to be consistent; whether to require to use a protected management frame in the sensing measurement; a type of a sensing measurement report; a measurement periodicity of the sensing measurement; a periodicity of reporting a sensing measurement report by the sensing-by-proxy responder; a measurement duration of the sensing measurement; information of a number of sensing participants participating in the sensing measurement; device information of sensing participants specified to participate in the sensing measurement; an indication of roles of at least one sensing participant participating in the sensing measurement in the sensing measurement; or time information of a sensing-by-proxy requester for performing a service related to the sensing measurement.

In some embodiments, the information of the number of sensing participants participating in the sensing measurement includes any one of: a minimum number of sensing participants participating in the sensing measurement; or a specific number of sensing participants participating in the sensing measurement.

In some embodiments, the indication of the roles of at least one sensing participant participating in the sensing measurement in the sensing measurement includes any one of: an indication, by the sensing-by-proxy responder, of the roles of the at least one sensing participant in the sensing measurement; an indication that the at least one sensing participant plays a same role in the sensing measurement; or an indication of roles of various sensing participants in the sensing measurement.

In some embodiments, the time information of the sensing-by-proxy requester for performing the service related to the sensing measurement includes at least one of: a duration of participating in the sensing measurement by the sensing-by-proxy initiator; a duration of receiving the sensing measurement report by the sensing-by-proxy initiator; or a periodicity for the sensing-by-proxy initiator to request the sensing-by-proxy responder to perform the sensing measurement on behalf of the sensing-by-proxy initiator.

In some embodiments, the sensing-by-proxy request frame includes at least one of: a Sensing Measurement Parameters Element field, indicating a common measurement configuration effective for at least one sensing participant; an Availability Window Element field, indicating time information of a sensing-by-proxy requester for performing a service related to the sensing measurement; an SBP Specific Parameters Element field, indicating information related to establishing the sensing measurement; a Minimum Sensing Participants Number field, indicating a specific number or a minimum number of sensing participants participating in the sensing measurement; a Sensing-by-Proxy Responder Determined Role field, indicating whether roles of at least one sensing participant in the sensing measurement are indicated by the sensing-by-proxy responder; or a Determined Sensing Responder Number field, indicating that a number of sensing participants participating in the sensing measurement indicated in a Minimum Sensing Participants Number field is a specific number or a minimum number of sensing participants participating in the sensing measurement.

In some embodiments, the role of the sensing-by-proxy initiator in the sensing measurement includes any one of: a sensing signal transmitter; a sensing signal receiver; a sensing signal transmitter and a sensing signal receiver; an unspecified role; or not participating in the sensing measurement.

In some embodiments, the sensing-by-proxy response frame carries at least one of following pieces of information: a measurement setup identifier of the sensing measurement; or measurement start time of the sensing measurement.

In some embodiments, the transmitter module 2120 is configured to: transmit the sensing-by-proxy response frame to the sensing-by-proxy initiator prior to initiating a measurement setup of the sensing measurement; transmit the sensing-by-proxy response frame to the sensing-by-proxy initiator after initiating a measurement setup of the sensing measurement; or transmit the sensing-by-proxy response frame to the sensing-by-proxy initiator after completing a measurement setup of the sensing measurement.

In some embodiments, a duration between a transmission time of the sensing-by-proxy request frame and a reception time of the sensing-by-proxy response frame is less than or equal to a first interval.

In some embodiments, the transmitter module 2120 is further configured to transmit sensing capability information to the sensing-by-proxy initiator; and the receiver module 2110 is further configured to receive sensing capability information from the sensing-by-proxy initiator.

In some embodiments, the sensing capability information carries information indicating at least one of: support of sensing-by-proxy measurement; or a maximum number of supported measurement setups that are run concurrently.

In summary, in the technical solutions according to the embodiments of the present disclosure, the sensing-by-proxy initiator transmits the sensing-by-proxy request frame to the sensing-by-proxy responder, such that the sensing-by-proxy responder initiates the sensing measurement based on the sensing-by-proxy request frame. Thus, the sensing-by-proxy initiator does not need to initiate the sensing measurement by itself, such that requirements on device parameters of the sensing-by-proxy initiator are lowered, and an application range of the sensing measurement is expanded.

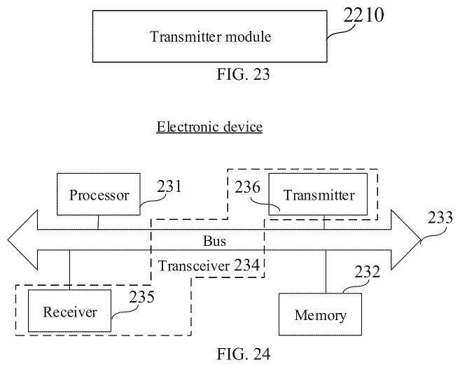

FIG. 23 is a block diagram of a capability interaction apparatus according to some embodiments of the present disclosure. The apparatus includes a transmitter module 2210.

The transmitter module 2210 is configured to transmit sensing capability information to a second communication device, wherein the sensing capability information carries at least one of following pieces of information: whether to support sensing-by-proxy measurement; or a maximum number of supported concurrent measurement setups.

Referring to FIG. 24, is a schematic structural diagram of a WLAN device 230 according to some embodiments of the present disclosure. The WLAN device 230 includes a processor 231, a memory 232, and a bus 233.

The processor 231 includes one or more processing cores, and achieves various functional applications and information processing by running software programs and modules.

The memory 232 is connected to the processor 231 through the bus 233.

The memory 232 is configured to store one or more computer programs, and the processor 231, when loading and running the one or more computer programs, is caused to perform various processes performed by the WLAN device in the above method embodiments.

In addition, the memory 232 is practiced by any type of volatile or non-volatile storage device or combinations thereof. The volatile or non-volatile storage device includes but is not limited to a random-access memory (RAM), a read-only memory (ROM), an erasable programmable read-only memory (EPROM), an electrically erasable programmable read-only memory (EEPROM), a flash memory or other solid memories, a compact disc read-only memory (CD-ROM), a high density digital video disc (DVD) or other optical memories, a disk or optical disc, a cassette, a magnetic tape, a disk memory, or other magnetic storage devices.

In the case that the WLAN device 230 is a sensing-by-proxy initiator, the WLAN device 230 is configured to transmit a sensing-by-proxy request frame to a sensing-by-proxy responder, wherein the sensing-by-proxy request frame is for requesting the sensing-by-proxy responder to perform sensing measurement on behalf of the sensing-by-proxy initiator; and receive a sensing-by-proxy response frame from the sensing-by-proxy responder.

In the case that the WLAN device 230 is a sensing-by-proxy responder, the WLAN device 230 is configured to receive a sensing-by-proxy request frame from a sensing-by-proxy initiator, wherein the sensing-by-proxy request frame is for requesting the sensing-by-proxy responder to perform sensing measurement on behalf of the sensing-by-proxy initiator; and transmit a sensing-by-proxy response frame to the sensing-by-proxy initiator.

In the case that the WLAN device 230 is a first communication device, the WLAN device 230 is configured to transmit sensing capability information to a second communication device, wherein the sensing capability information carries at least one of following pieces of information: whether to support sensing-by-proxy measurement; or a maximum number of supported measurement setups that are run concurrently.

In some embodiments, the WLAN device 230 further includes a transceiver 234 connected to the processor 231, and the transceiver 234 includes a receiver 235 and a transmitter 236.

For details not described in the embodiments, reference may be made to the above embodiments, which is not described herein any further.

Some embodiments of the present disclosure further provide a computer-readable storage medium storing one or more computer programs, wherein the one or more computer programs, when loaded and run by a computer device, cause the computer device to perform the sensing measurement method applicable to the sensing-by-proxy initiator.

Some embodiments of the present disclosure further provide a computer-readable storage medium storing one or more computer programs, wherein the one or more computer programs, when loaded and run by a computer device, cause the computer device to perform the sensing measurement method applicable to the sensing-by-proxy responder.

Some embodiments of the present disclosure further provide a computer-readable storage medium storing one or more computer programs, wherein the one or more computer programs, when loaded and run by a computer device, cause the computer device to perform the capability interaction method applicable to the first communication device.

In some embodiments, the computer-readable storage medium includes: a ROM, a RAM, a solid state drive (SSD), an optical disc, or the like. The RAM includes a resistance random access memory (ReRAM) and a dynamic random access memory (DRAM).

Some embodiments of the present disclosure further provide a chip. The chip includes programmable logic circuitry and/or program instructions, and is configured to perform the sensing measurement method applicable to the sensing-by-proxy initiator.

Some embodiments of the present disclosure further provide a chip. The chip includes programmable logic circuitry and/or program instructions, and is configured to perform the sensing measurement method applicable to the sensing-by-proxy responder.

Some embodiments of the present disclosure further provide a chip. The chip includes programmable logic circuitry and/or program instructions, and is configured to perform the capability interaction method applicable to the first communication device.

Some embodiments of the present disclosure further provide a computer program product including one or more computer instructions therein. The one or more computer instructions are stored in a computer-readable storage medium, and when read from the computer-readable storage medium, loaded and executed by a computer device, cause the computer device to perform the sensing measurement method applicable to the sensing-by-proxy initiator.

Some embodiments of the present disclosure further provide a computer program product including one or more computer instructions therein. The one or more computer instructions are stored in a computer-readable storage medium, and when read from the computer-readable storage medium, loaded and executed by a computer device, cause the computer device to perform the sensing measurement method applicable to the sensing-by-proxy responder.

Some embodiments of the present disclosure further provide a computer program product including one or more computer instructions therein. The one or more computer instructions are stored in a computer-readable storage medium, and when read from the computer-readable storage medium, loaded and executed by a computer device, cause the computer device to perform the capability interaction method applicable to the first communication device.

It should also be understood that the term “indication” in the embodiments of the present disclosure refers to direct or indirect indication, or an associated relationship. Illustratively, in the case that A indicates B, it means that: A directly indicates B, for example, B can be acquired through A; A indirectly indicates B, for example, A indicates C, and B can be acquired through C; or A and B have an association relationship.

In some embodiments of the present disclosure, the term “correspondence” means that there is a direct correspondence or indirect correspondence between the two objects, there is an association between the two objects, or there is a relationship of indicating and being indicated, configuring and being configured, or the like.

The term “a plurality of” herein means two or more. The term “and/or” herein describes associations between associated objects, and indicates three types of relationships. For example, the phrase “A and/or B” means (A), (B), or (A and B). The symbol “/” generally indicates an “or” relationship between the associated objects.

The term “less than or equal to” means (less than and equal to) or (less than).

In addition, the serial number of the processes described herein only illustrates a possible sequence of performing the processes. In some embodiments, the above processes may be not performed in the above serial number, for example, processes of two different serial numbers are performed simultaneously, or processes of two different serial numbers are performed in an order opposite to that illustrated in the drawing, which is not limited in the present disclosure.

It should be understood by those skilled in the art that in the above one or more embodiments, functions described in the embodiments of the present disclosure are practiced by the hardware, the software, the firmware or any combinations thereof. In the case that the functions are practiced by the software, the functions are stored in the computer-readable storage medium or are determined as one or more instructions or codes in the computer-readable storage medium for transmission. The computer-readable storage medium includes a computer storage medium and a communication medium, and the communication medium includes any medium facilitating transmission of the computer program from one place to another place. The storage medium is any available medium accessible by a general or specific computer.

Described above are merely exemplary embodiments of the present disclosure, and are not intended to limit the present disclosure. Any modifications, equivalent replacements, improvements and the like made within the spirit and principles of the present disclosure should be encompassed within the scope of protection of the present disclosure.

1. A sensing measurement method, applicable to a sensing-by-proxy initiator, the method comprising:
transmitting a sensing-by-proxy request frame to a sensing-by-proxy responder, wherein the sensing-by-proxy request frame is for requesting the sensing-by-proxy responder to perform sensing measurement on behalf of the sensing-by-proxy initiator; and
receiving a sensing-by-proxy response frame from the sensing-by-proxy responder.

2. The method according to claim 1, wherein the sensing-by-proxy request frame carries information indicating at least one of:
whether to require the sensing-by-proxy responder to obtain a sensing measurement report of the sensing measurement;
an accuracy requirement of a sensing measurement result;
a role of the sensing-by-proxy initiator in the sensing measurement;
whether to require sensing signal transmitters and sensing signal receivers in different sensing measurement instances to be consistent;
whether to require to use a protected management frame in the sensing measurement;
a type of a sensing measurement report;
a measurement periodicity of the sensing measurement;
a periodicity of reporting a sensing measurement report by the sensing-by-proxy responder;
a measurement duration of the sensing measurement;
information of a number of sensing participants participating in the sensing measurement;
device information of sensing participants specified to participate in the sensing measurement;
an indication of roles of at least one sensing participant participating in the sensing measurement in the sensing measurement; or
time information of a sensing-by-proxy requester for performing a service related to the sensing measurement.

3. The method according to claim 2, wherein the role of the sensing-by-proxy initiator in the sensing measurement comprises any one of:
a sensing signal transmitter;
a sensing signal receiver;
a sensing signal transmitter and a sensing signal receiver;
an unspecified role; or
not participating in the sensing measurement.

4. The method according to claim 2, wherein the information of the number of sensing participants participating in the sensing measurement comprises any one of:
a minimum number of sensing participants participating in the sensing measurement; or
a specific number of sensing participants participating in the sensing measurement.

5. The method according to claim 2, wherein the indication of the roles of at least one sensing participant participating in the sensing measurement in the sensing measurement comprises any one of:
an indication, by the sensing-by-proxy responder, of the roles of the at least one sensing participant in the sensing measurement;
an indication that the at least one sensing participant plays a same role in the sensing measurement; or
an indication of roles of various sensing participants in the sensing measurement.

6. The method according to claim 2, wherein the time information of the sensing-by-proxy requester for performing the service related to the sensing measurement comprises at least one of:
a duration of participating in the sensing measurement by the sensing-by-proxy initiator;
a duration of receiving the sensing measurement report by the sensing-by-proxy initiator; or
a periodicity for the sensing-by-proxy initiator to request the sensing-by-proxy responder to perform the sensing measurement on behalf of the sensing-by-proxy initiator.

7. The method according to claim 2, wherein the sensing-by-proxy request frame comprises at least one of following fields:
a Sensing Measurement Parameters Element field, indicating a common measurement configuration effective for at least one sensing participant;
an Availability Window Element field, indicating time information of a sensing-by-proxy requester for performing a service related to the sensing measurement;
an SBP Specific Parameters Element field, indicating information related to establishing the sensing measurement;
a Minimum Sensing Participants Number field, indicating a specific number or a minimum number of sensing participants participating in the sensing measurement;
a Sensing-by-Proxy Responder Determined Role field, indicating whether roles of at least one sensing participant in the sensing measurement are determined by the sensing-by-proxy responder; or
a Determined Sensing Responder Number field, indicating that a number of sensing participants participating in the sensing measurement indicated in a Minimum Sensing Participants Number field is a specific number or a minimum number of sensing participants participating in the sensing measurement.

8. The method according to claim 1, wherein the sensing-by-proxy response frame carries at least one of:
a measurement setup identifier of the sensing measurement; or
measurement start time of the sensing measurement.

9. A wireless local area network (WLAN) device, comprising:
a processor and a memory storing one or more computer programs, which when executed by the processor, cause the WLAN device to:
transmit a sensing-by-proxy request frame to a sensing-by-proxy responder, wherein the sensing-by-proxy request frame is for requesting the sensing-by-proxy responder to perform sensing measurement on behalf of the WLAN device; and
receive a sensing-by-proxy response frame from the sensing-by-proxy responder.

10. The WLAN device according to claim 9, wherein the sensing-by-proxy request frame carries information indicating at least one of:
whether to require the sensing-by-proxy responder to obtain a sensing measurement report of the sensing measurement;
an accuracy requirement of a sensing measurement result;
a role of a sensing-by-proxy initiator in the sensing measurement;
whether to require sensing signal transmitters and sensing signal receivers in different sensing measurement instances to be consistent;
whether to require to use a protected management frame in the sensing measurement;
a type of a sensing measurement report;
a measurement periodicity of the sensing measurement;
a periodicity of reporting a sensing measurement report by the sensing-by-proxy responder;
a measurement duration of the sensing measurement;
information of a number of sensing participants participating in the sensing measurement;
device information of sensing participants specified to participate in the sensing measurement;
an indication of roles of at least one sensing participant participating in the sensing measurement in the sensing measurement; or
time information of a sensing-by-proxy requester for performing a service related to the sensing measurement.

11. The WLAN device according to claim 10, wherein the role of the sensing-by-proxy initiator in the sensing measurement comprises any one of:
a sensing signal transmitter;
a sensing signal receiver;
a sensing signal transmitter and a sensing signal receiver;
an unspecified role; or
not participating in the sensing measurement.

12. The WLAN device according to claim 10, wherein the information of the number of sensing participants participating in the sensing measurement comprises any one of:
a minimum number of sensing participants participating in the sensing measurement; or
a specific number of sensing participants participating in the sensing measurement.

13. A wireless local area network (WLAN) device, comprising:
a processor and a memory storing one or more computer programs, which when executed by the processor, cause the WLAN device to:
receive a sensing-by-proxy request frame from a sensing-by-proxy initiator, wherein the sensing-by-proxy request frame is for requesting a sensing-by-proxy responder to perform sensing measurement on behalf of the sensing-by-proxy initiator; and
transmit a sensing-by-proxy response frame to the sensing-by-proxy initiator.

14. The WLAN device according to claim 13, wherein the sensing-by-proxy request frame carries information indicating at least one of:
whether to require the sensing-by-proxy responder to obtain a sensing measurement report of the sensing measurement;
an accuracy requirement of a sensing measurement result;
a role of the sensing-by-proxy initiator in the sensing measurement;
whether to require sensing signal transmitters and sensing signal receivers in different sensing measurement instances to be consistent;
whether to require to use a protected management frame in the sensing measurement;
a type of a sensing measurement report;
a measurement periodicity of the sensing measurement;
a periodicity of reporting a sensing measurement report by the sensing-by-proxy responder;
a measurement duration of the sensing measurement;
information of a number of sensing participants participating in the sensing measurement;
device information of sensing participants specified to participate in the sensing measurement;
an indication of roles of at least one sensing participant participating in the sensing measurement in the sensing measurement; or
time information of a sensing-by-proxy requester for performing a service related to the sensing measurement.

15. The WLAN device according to claim 14, wherein the role of the sensing-by-proxy initiator in the sensing measurement comprises any one of:
a sensing signal transmitter;
a sensing signal receiver;
a sensing signal transmitter and a sensing signal receiver;
an unspecified role; or
not participating in the sensing measurement.

16. The WLAN device according to claim 14, wherein the information of the number of sensing participants participating in the sensing measurement comprises any one of:
a minimum number of sensing participants participating in the sensing measurement; or
a specific number of sensing participants participating in the sensing measurement.

17. The WLAN device according to claim 14, wherein the indication of the roles of at least one sensing participant participating in the sensing measurement in the sensing measurement comprises any one of:
an indication, by the sensing-by-proxy responder, of the roles of the at least one sensing participant in the sensing measurement;
an indication that the at least one sensing participant plays a same role in the sensing measurement; or
an indication of roles of various sensing participants in the sensing measurement.

18. The WLAN device according to claim 14, wherein the time information of the sensing-by-proxy requester for performing the service related to the sensing measurement comprises at least one of:
a duration of participating in the sensing measurement by the sensing-by-proxy initiator;
a duration of receiving the sensing measurement report by the sensing-by-proxy initiator; or
a periodicity for the sensing-by-proxy initiator to request the sensing-by-proxy responder to perform the sensing measurement on behalf of the sensing-by-proxy initiator.

19. The WLAN device according to claim 14, wherein the sensing-by-proxy request frame comprises at least one of following fields:
a Sensing Measurement Parameters Element field, indicating a common measurement configuration effective for at least one sensing participant;
an Availability Window Element field, indicating time information of a sensing-by-proxy requester for performing a service related to the sensing measurement;
an SBP Specific Parameters Element field, indicating information related to establishing the sensing measurement;
a Minimum Sensing Participants Number field, indicating a specific number or a minimum number of sensing participants participating in the sensing measurement;
a Sensing-by-Proxy Responder Determined Role field, indicating whether roles of at least one sensing participant in the sensing measurement are determined by the sensing-by-proxy responder; or
a Determined Sensing Responder Number field, indicating that a number of sensing participants participating in the sensing measurement indicated in a Minimum Sensing Participants Number field is a specific number or a minimum number of sensing participants participating in the sensing measurement.

20. The WLAN device according to claim 13, wherein the sensing-by-proxy response frame carries at least one of:
a measurement setup identifier of the sensing measurement; or
measurement start time of the sensing measurement.
